(19) United States
(12) Patent Application Publication
(10) Pub. No.: US 2016/0042312 A1
(43) Pub. Date: Feb. 11, 2016

(54) SYSTEM AND METHOD FOR AN INTERNET-ENABLED MARKETPLACE FOR COMMERCIAL WAREHOUSE STORAGE AND SERVICES

(71) Applicants: Karl Siebrecht, Seattle, WA (US); Francis Duong, Seattle, WA (US); Edmond Sin Hang Yue, Seattle, WA (US)

(72) Inventors: Karl Siebrecht, Seattle, WA (US); Francis Duong, Seattle, WA (US); Edmond Sin Hang Yue, Seattle, WA (US)

(73) Assignee: FLEXE, INC., SEATTLE, WA (US)

(21) Appl. No.: 14/819,754

(22) Filed: Aug. 6, 2015

Related U.S. Application Data
(60) Provisional application No. 62/033,872, filed on Aug. 6, 2014.

(51) Int. Cl. G06Q 10/08

(52) U.S. Cl. CPC G06Q 10/087

(57) ABSTRACT

Systems and methods that facilitate commercial warehouse storage and services transactions can include the acts of receiving listings of commercial warehouse spaces available for storage and services, wherein each of the listings comprises space data describing the spaces; receiving a search request for space in which goods can be stored, wherein the search request comprises goods data associated with the goods; receiving a request to store the goods in a requested space associated with a requested listing from the listing; providing the request to a Storer associated with the requested space; receiving approval from the Storer to store the goods in the requested space; and coordinating transportation of the goods to the requested space and materials handling. The method can provide for tracking inventory and billing associated with the goods while at the requested space and coordinating removal of the goods from the space in response to a pick-up request.

### CROSS-REFERENCE TO RELATED APPLICATIONS

This application claims the benefit of U.S. Provisional Patent application Ser. No. 62/033,872 entitled “SYSTEM AND METHOD FOR AN INTERNET-ENABLED MARKETPLACE FOR COMMERCIAL WAREHOUSE STORAGE” and filed Aug. 6, 2014. The entirety of the above-noted application is incorporated by reference herein.

### BACKGROUND

Frequently, owners and operators of commercial warehouse spaces (“Storers”) have unused storage capacity, but have difficulty finding and coordinating storage with parties that have goods they wish to store (“Goods Owners”). This problem becomes exacerbated as goods move in and out of warehouses at various times, making it difficult to maximize the utilized capacity of the warehouse. Additionally, from the perspective of a Goods Owner, it can be difficult to find warehouse capacity that meets the needs of the Goods Owner while minimizing expenses, transportation time, etc. Further, Storers often must manually handle logistics of storing the goods.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The subject innovation disclosed and claimed herein, in one aspect thereof, comprises systems and methods that facilitate commercial warehouse storage and services transactions. One such system includes a warehouse device that facilitates commercial warehouse services transactions, comprising a matching component that matches a search request for space in which a set of goods can be stored, wherein the search request comprises goods data associated with the set of goods to one or more listings of one or more commercial warehouse spaces available for storage where each of the one or more listings comprises space data describing the one or more spaces; and a transaction component that receives approval from a Storer to store the goods in the requested space.

One such method can include the acts of receiving one or more listings of one or more commercial warehouse spaces available for storage and warehousing services, wherein each of the one or more listings comprises space data describing the one or more spaces and services provided; receiving a search request for space in which a set of goods can be stored, wherein the search request comprises goods data associated with the set of goods; searching the one or more listings based at least in part on the goods data and the space data of the one or more listings; providing at least one listing of the one or more listings as a search result; receiving a request to store the set of goods in a requested space associated with a requested listing from the at least one listing; providing the request to a Storer associated with the requested space; receiving approval from the Storer to store the goods in the requested space and provide the requested warehousing services; coordinating transportation of the set of goods to the requested space; and coordinating materials handling of the goods including sorting, labeling, etc. Additionally, such a method can provide for tracking inventory and billing associated with the set of goods while at the requested space and coordinating removal of the set of goods from the requested space in response to a pick-up request.

Another such system includes a computer readable medium having instructions for controlling one or more processors configured to facilitate storage of a set of goods in response to a search request, wherein the search request comprises goods data associated with the set of goods to one or more listings of one or more commercial warehouse spaces available for storage where each of the one or more listings comprises space data describing the one or more spaces; and apply warehouse services on the set of goods.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same can be arbitrarily increased or reduced for clarity of discussion, for example.

FIG. 1 illustrates an input/output diagram to facilitate commercial warehouse storage transactions in accordance with aspects of the subject innovation.

FIG. 2 illustrates a system that can facilitate commercial warehouse storage and services transactions in accordance with aspects of the subject innovation.

FIG. 3 illustrates a method of facilitating commercial warehouse storage transactions in accordance with aspects of the subject innovation.

FIG. 4 illustrates an example screenshot in connection with a Storer listing space at a warehouse available for storing goods.

FIG. 5 illustrates a second example screenshot in connection with a Storer listing space at a warehouse available for storing goods, showing optional features related to listing racked space and market pricing information.

FIG. 6 illustrates a third screenshot in connection with a Storer listing space at a warehouse available for storing goods, showing optional features related to floor loaded space, price setting, and stackable and non-stackable pallets.

FIG. 7 illustrates a fourth screenshot in connection with a Storer listing space at a warehouse available for storing goods, showing optional features related to in and out loading fees, available dates, etc.

FIG. 8 illustrates an example screenshot in connection with a Goods Owner searching for storage space for goods.

FIG. 9 illustrates an example screenshot of search results for commercial warehouse storage space available in response to a search request.

FIG. 10 illustrates an example screenshot of a listing of a commercial storage warehouse space as presented to a Goods Owner.

FIG. 11 illustrates an example screenshot of a request to reserve commercial warehouse space by a Goods Owner.

FIG. 12 illustrates an example screenshot showing reservations of commercial warehouse storage space by a Goods Owner.

FIG. 13 illustrates an example screenshot of a Goods Owner scheduling a delivery to a warehouse.

FIG. 14 illustrates an example screenshot of a scheduled delivery of goods to a warehouse.

FIG. 15 illustrates an example screenshot of a scheduled pickup of goods from a warehouse.

FIG. 16 illustrates an example screenshot of a shipping list of goods to be delivered to a warehouse.

FIG. 17 illustrates a portion of an example printout confirmation of a drop-off schedule.

FIG. 18 illustrates a portion of an example printout confirmation of a drop-off schedule, detailing palleting and stacking requirements.

FIG. 19 illustrates a portion of an example printout confirmation of a drop-off schedule, detailing instructions for securing pallets.

FIG. 20 illustrates a portion of an example printout confirmation of a drop-off schedule, detailing instructions for tagging and labeling pallets.

FIG. 21 illustrates a portion of an example printout of a pallet label, showing one of two bar codes to be attached to a first pallet in connection with the goods.

FIG. 22 illustrates an example screenshot of an invoice for a reservation of commercial warehouse storage space.

FIG. 23 illustrates an example screenshot of a statement detailing goods stored at a particular warehouse, along with associated charges.

FIG. 24 illustrates an example screenshot of an inventory management interface, showing an overview of what a Goods Owner has stored at warehouses associated with the subject innovation.

FIG. 25 illustrates an example screenshot of an inventory management interface, showing options to add new inventory items, either individually or imported from a file.

FIG. 26 illustrates an example screenshot of an inventory management interface, showing new inventory items being added via importing items from a CSV file.

FIG. 27 illustrates an example screenshot of an inventory management interface, showing an inventory pickup interface.

FIG. 28 illustrates an example screenshot of an inventory management interface, showing the results of a proposed inventory pickup generated by the subject innovation.

FIG. 29 illustrates a computer-readable medium or computer-readable device comprising processor-executable instructions configured to embody one or more of the provisions set forth herein, according to some embodiments.

FIG. 30 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It can be evident, however, that the innovation can be practiced without these specific details. In other instances, well-known structures and devices are shown in block diagram form in order to facilitate describing the innovation.

As used in this application, the terms “component,” “module,” “system,” “interface,” and the like are generally intended to refer to a computer-related entity, either hardware, a combination of hardware and software, software, or software in execution. For example, a component can be, but is not limited to being, a process running on a processor, a processor, an object, an executable, a thread of execution, a program, or a computer. By way of illustration, both an application running on a controller and the controller can be a component. One or more components residing within a process or thread of execution and a component can be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications can be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, tablet, or other suitable device, for example) where the layout and information or content to be displayed on the page is stored in memory, database, or another storage facility.

In various aspects, the subject innovation can comprise systems and methods that can facilitate a marketplace for commercial warehouse storage and services via a communications infrastructure (e.g., the Internet, etc.). Embodiments of the subject innovation can facilitate owners or lessors of commercial warehouse space (“Storers”) generating additional income by storing others' goods in their warehouse(s). For owners of goods (“Goods Owners”), the subject innovation can facilitate the ability to find and use commercial storage space that meets their requirements. In various aspects, services can include, but need not be limited to, bulk storage (e.g., for pallets and otherwise), de-vanning, palletization, labeling, outbound shipping, transportation management, transportation coordination, etc. In accordance with aspects of the subject innovation, Storers can list warehouse space via the subject innovation, indicating the amount of space (e.g., in pallets, etc.) made available for storage services, and pricing for storage and ancillary services can be set by each Storer.

In various embodiments, the subject innovation can comprise an online marketplace for commercial warehouse space that can be accessed via a website. The subject innovation can provide online tools to help bring together Storers and Goods Owners, and can facilitate operational transactions among them. In various aspects, aspects of the subject innovation can generate revenue for an associated entity (e.g., a company employing an embodiment of the subject innovation, etc.). Revenue can be generated via one or more of applying a markup to Storers' prices (e.g., a fixed amount, a percentage, etc.), charging a license fee for usage of the subject innovation (e.g., from Storers, Goods Owners, third parties, etc.), charging fees to access a marketplace generated by the subject innovation, enabling premium marketing/listing opportunities for Storers for a fee, selling analytical insights generated through marketplace data generated by and held in the software System, selling advertising opportunities in connection with the subject innovation, selling ancillary services such as insurance, etc. In some embodiments, the subject innovation can facilitate arrangement and coordination of transportation or other services in connection with goods to be stored by Goods Owners in connection with Storers connected with via the subject innovation.

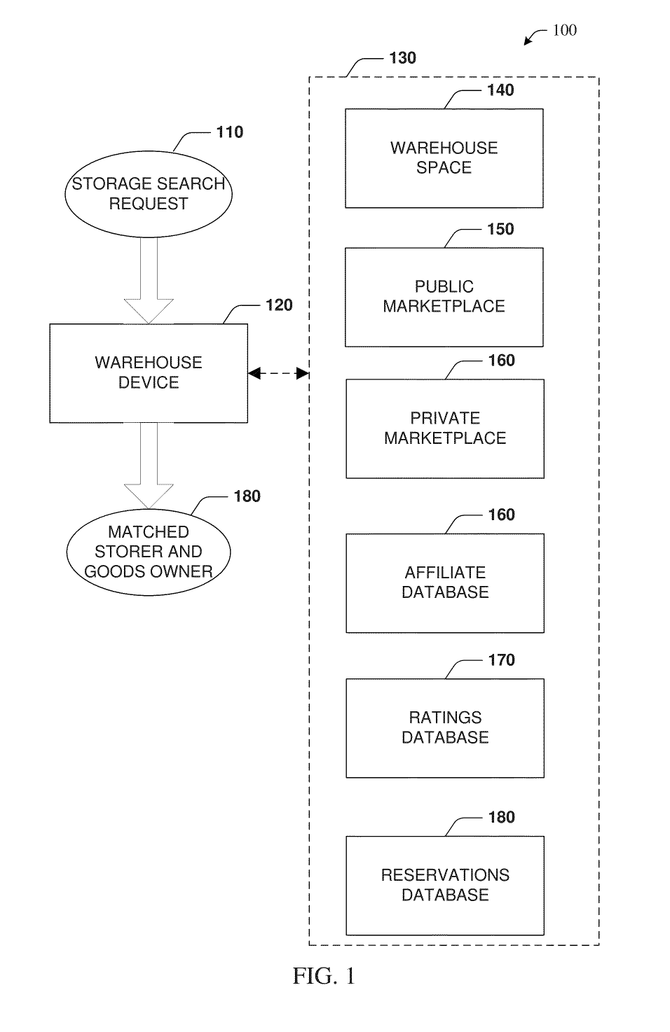

With reference to FIG. 1, an input/output diagram 100 for facilitating storage transactions is depicted. A storage request 110 from a Goods owner details storage factors and/or requirements and is received by a warehouse device 120. The warehouse device 120 accesses information sources and other information 130 to facilitate responding to the storage request.

The warehouse device 120 facilitates Storers listing warehouse space 140 as available. The warehouse space 140 includes one or more listings of different spaces that can be entered as available by different Storers. In one embodiment, the warehouse space 140 includes listings 4 via a marketplace, which can be accessed, for example, via a website, application software, etc. Such a marketplace is described in detail below. Each of the one or more listings can include information specifying details associated with the space, which can include information associated with the space, some of which can be required in embodiments of the subject innovation. This information can include a location of the warehouse in which the space is available; an amount or capacity of space available (e.g., in pallets, units of area (e.g., square feet, etc.), etc.); a time period of availability; prices for storage per unit (e.g., pallet) per time unit (e.g., day, etc.) and per unit for load-in or load-out of units, as well as any pricing for additional or ancillary services offered (in various embodiments, prices can vary based one or more factors, such as by length of storage commitment available, etc.); maximum pallet weight associated with the space; maximum pallet height associated with the space; whether racking is available or not, as well as additional details (e.g., how many pallets high, associated heights, weights, and racking capacity, etc.); a quality description or class associated with the space (e.g., received from a Storer associated with the space, based on community ratings from users that have interacted with the space, etc.); operating hours associated with the space; whether security systems are available with the space (and descriptions or details when in place); whether sprinkler systems of a certain type are associated with the space; whether there are dock-high doors; specific handling requirements or qualifications associated with the space (e.g., refrigeration capability, food handling qualifications, pharmaceutical handling qualifications, etc.); whether insurance coverage is provided, and details on coverage where provided; any other services provided (e.g., pick/pack individual orders, kitting, assembly, etc.); and the like.

In aspects, Storers can list available spaces within a “public” marketplace 150 whereby listings will be available to all Goods Owners interacting with the warehouse device 120. Storers can also list within a “private” marketplace 160 in which Storers can have control over which Goods Owners can see their listings and purchase the Storer's services (e.g., store pallets in a space listed by the Storer, purchase other associated services, etc.).

In either marketplace, Storers can add photographs and other ancillary information to help market and promote available spaces. In aspects, the subject innovation can provide information on capacity in use and/or already reserved to Storers based on spaces they have listed, which can help Storers keep information on capacity available accurate and up to date. In various embodiments, the subject innovation can either make detailed contact information for a given Storer available to all or some registered users at all steps in the search process, or keep it confidential until a Goods Owner reaches a given phase in the purchase process.

In aspects, Goods Owners can search within a “public” marketplace (e.g., with listings available to all registered users, etc.), or within a self-defined “private” marketplace of Storers as selected (e.g., which can be limited to those that are ‘pre-approved,’etc.) by a specific Goods Owner that cannot be visible or available to other Goods Owners (e.g., depending on how the Storer has chosen to list the space(s), etc.). In aspects, a Goods Owner can create the storage request 110 indicating a need for storage that can be made available to some or all Storers, which can be implemented via a reverse-auction functionality. Goods Owners can include information in the storage request 110 which can include a price they are willing to pay, as well as other required and/or optional information.

In further aspects, the warehouse device 120 interacts with an affiliate database 160. The affiliate database 160 stores and provides access to one or more third parties, affiliates, or partners, such as brokers, freight providers, etc. One or more parties other than direct Goods Owners or Storers (“third parties” or “affiliates”) can help facilitate transactions by and among Goods Owners and Storers in connection with embodiments of the subject innovation. In one embodiment, affiliates include, but are not limited to, commercial real estate brokers, freight forwarders, freight brokers, etc. In various embodiments, Affiliates can be registered users of an embodiment of the warehouse device 120, and can perform some or all of the listing, searching or other functions on behalf of or to the benefit of Goods Owners and/or Storers. In aspects, the affiliate database 160 can provide for the ability of affiliates to earn commissions or other such finder's fees for facilitating transactions. The affiliate database 160 allows for affiliates to promote or market themselves through various features, for example, enabling branded reports, document generation, etc.

In various embodiments, Goods Owners can be provided with additional information about recommended results from a ratings database 170. The ratings database provides the warehouse device 120 with feedback information regarding the Storers listed in the marketplace. The information available can include, but is not limited to, rating information which can be based on one or more of registered users' experience(s) with a provider (e.g., user comments and/or “Star rating”). In one embodiment, the ratings database 170 compiles information about the Storers including, but not limited to, length of tenure within the marketplace, number of transactions completed within the marketplace, operational performance within the marketplace based on metrics such as historical error rates, etc.

In various aspects, the warehouse device 120 interacts with a reservations database 180. The reservations database can accept reservations for warehouse space in advance and update the availability of warehouse space of Storers. Goods Owners can make specific reservations with Storers in advance using the reservations database 180. Embodiments of the subject innovation can automatically update a Storer's capacity available in its listing to reflect the impact of new reservations as they are booked. In one embodiment, a reservation can include a specific financial commitment, and the subject innovation can be configurable in handling different scenarios for reservation cancellation in terms of financial obligations (e.g., reservation fees returned or not, etc.).

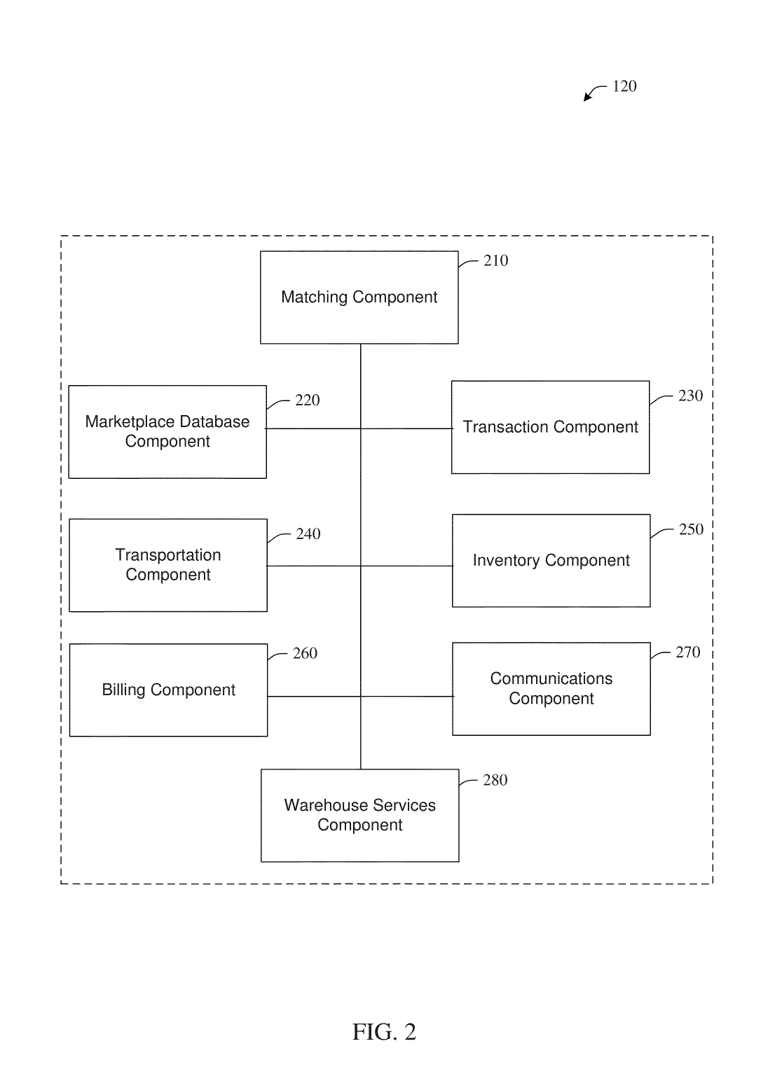

With reference to FIG. 2, and continuing reference to FIG. 1, a component diagram of the warehouse device 120 that facilitates commercial warehouse storage transactions is depicted in accordance with aspects of the subject innovation. The warehouse device 120 uses the data in the information sources 130 to match a Goods Owner that generated the storage request with a Storer 180.

The warehouse device 120 can include a matching component 210 that can receive one or more listings (e.g., from Storers, etc.) of commercial warehouse spaces available for storage of goods, where each listing can include details about the space. In one embodiment, the details can include quantity of space available (e.g., in terms of pallets, square feet, etc.), pricing (e.g., for load-in or load-out, storage over time, etc.), location, other details and information discussed herein, and the like.

Received listings can be maintained in a marketplace database component 220 that can be searched based on a variety of criteria, such as various information associated with listings and search requests (e.g., location, timing, price, capacity, etc.). The matching component 210 receives one or more search requests (e.g., from Goods Owners, etc.) for storage of a set of goods, where each search request can include data associated with the set of goods. For example, a search request can include a quantity of goods to be stored, location preferences, and the like.

In response to the search request, the matching component 210 searches the marketplace database component 220 based on the search request. The marketplace database component 220 returns one or more listings in response to the search request. In one embodiment, the returned listings can be listings that completely or partially correspond to search criteria (e.g., goods description, associated requirements or preferences, etc.), which can be ordered based on a variety of criteria (e.g., location, timing, price, quality, etc.).

Goods Owners interacting with the warehouse device 120 can search within the marketplace database component 220 (e.g., via a website, application software, etc.) for storage space that meets their requirements. Search criteria (e.g., for obtaining search results, filtering search results, ordering search results, etc.) can include any of the details that can be made available in connection with listings, which can include one or more of: location of available space; capacity available at a space (e.g., in pallets, etc.); time period(s) of availability of space; prices for storage per unit per day, prices for load-in and load-out, and prices for other ancillary services; maximum pallet weights of spaces; maximum pallet heights of spaces; whether racking is available or not, and details if available; quality of available space; operating hours; security systems; sprinkler systems; whether there are dock-high doors; whether a space can meet specific handling requirements or has certain qualifications (e.g., refrigeration, food handling qualifications, pharma handling qualifications, etc.); level of insurance coverage provided; etc.

In one embodiment, the matching component 210 implements one or more computer algorithms (e.g., as hardware, software in execution, etc.) to return recommended results from the Goods Owners' search request. Variables used by the algorithms for determining recommended results can include, but are not limited to: current and/or anticipated price for services desired, which can be based on listed prices in addition to supply and demand dynamics within the marketplace; location(s) of facility(s); estimated costs of transport given location(s) of Storer facility(s) and location(s) of other facilities within Goods Owners' supply chain; duration of storage needed relative to Storers guaranteed availability listed; special storage requirements like added security, temperature control, hazardous materials handling, etc.; real-time or near-real time variables such as weather, labor strikes, etc.; other required and/or desired characteristics of the storage space, such as those listed herein, etc.

The matching algorithms employed by the matching component 210 can be based on the data elements, variables, or other aspects described herein. The objective function and constraints of the matching algorithm(s) employed by the matching component 210 can be configurable and can include, but are not limited to: lowest cost of solution for Goods Owners; yield maximization for Storers; diversification of supply base from Storers; profit maximization for an entity controlling the subject innovation; etc.

Recommended results returned by a matching algorithm can be displayed on a map, and can include summary information about each listing that is recommended. Summary information can include, but is not limited to: photographs; price; location (e.g., approximate or specific, in one or more units, etc.), or other criteria or features described herein.

In response to returned search results, warehouse device 120 can receive a storage request to store goods in a requested space via a transaction component 230. The transaction component 230 provides the storage request to a Storer associated with the requested space. The transaction component 230 receives an authorization from the Storer in connection with the storage request. The transaction component 230 creates a reservation which can be updated to the reservations database 180.

A transportation component 240 coordinates transportation of the goods to the space. The transportation component 240 can coordinate transportation and/or movement of goods using the affiliate database 160. In terms of managing the movement of goods, the transportation component 240 enables movement of goods between Goods Owners' facilities or facilities of Goods Owners' other service providers and transportation providers and Storers' facilities. The transportation component 240 can comprise functionality for management of goods that can include, but is not limited to: a Goods Owner can request movement of specific goods to a Storer in a specific amount (e.g., # of pallets, etc.) on a specific date; a Storer can confirm or decline the ability to receive goods per a requested order; a Goods Owner can request movement of specific goods from a Storer in a specific amount on a specific date, and to a specific location; a Storer can confirm or decline the ability to send goods out per a requested order; a Goods Owner and/or a Storer can facilitate pickup and/or drop-off information with transportation providers through functionality of the subject innovation, including but not limited to, packing lists, etc.; a Goods Owner or a Storer can cancel or reschedule an existing order; a Goods Owner and/or a Storer can provide confirmation that a given order is completed and Goods are accounted for; etc.

The goods can be made up of different units such as pallets and the like. An inventory component 250 generates identifiers (e.g., unique bar codes, radio frequency identification (RFID) tags, etc.) for each unit of the goods. Once the units are marked with the identifiers, the inventory component 150 maintains location and other details associated with each unit of the goods. The inventory component 150 can track the location by scanning in the identifiers as the goods change location. The inventory component 250 can provide detailed information on which units of goods are in which location for all of the goods stored at various spaces to a Goods Owner. In one embodiment, the inventory component 250 can allow goods be tracked by various parties such as Goods Owners, Storers, third parties such as shipping companies, and the like.

In one embodiment, the inventory component 250, in various aspects, can enable creation of unique System identifiers (“System ID”) that can be created for each unit stored by a Goods Owner (which can include, but is not limited to, a unique Pallet ID, etc.). These identifiers includes bar code and/or other tags (e.g., RFID, etc.) that can automate physical goods tracking. System IDs can be consistent to and visible to the Storer and the Goods Owner involved in each transaction. The system IDs can be read by multiple physical goods tracking technologies including barcode scanners, smartphones with barcode scanning apps, etc. in barcode embodiments, RFID scanners or near field communications (NFC) enabled devices in electronic identifier embodiments (e.g., RFID tags, etc.); etc. In various embodiments, the inventory component 250 can enable Goods Owners to map one or more additional fields of information to each system ID to further describe the goods and integrate each item into Goods Owners' existing inventory management systems. Examples include, but are not limited to, SKU numbers, product names, order numbers, etc. Such mapping can be done through manual data entry and/or via more automated means including API integration, EDI integration, etc.

The inventory component 250 can enable Storers to map one or more additional fields of information to each System ID to facilitate storage location and retrieval within Storers' existing warehouse management systems. Examples include, but are not limited to, storage location, etc. Such mapping can be done through manual data entry and/or via more automated means including API integration, EDI integration, etc.

The inventory component 250 can generate reports that allow both Goods Owners and Storers to view their goods stored and goods being stored, respectively, to aid in decision making and management of goods and/or capacity. Information available for reporting include, but are not limited to: System ID; Mapped IDs or descriptions; days stored; costs incurred/revenue generated; orders reserved to be executed; dates; Goods Owner name/ID; Storer name/ID; etc. The inventory component 250 can enable Goods Owners and Storers to search for goods by Mapped IDs or descriptions.

A billing component 260 maintains billing information associated with each individual unit of goods. For example, the billing information 260 can maintain load-in and load-out prices, prices per unit time for each unit of goods, pricing for ancillary services and the like. The billing component 260 facilitates billing and invoicing management. The billing component 260 generates baseline data to facilitate accurate billing, and generates invoices for Goods Owners. Baseline data can include, but is not limited to: System ID (e.g., object or pallet), unit and/or goods counts, dates received and shipped out, days stored, price per unit, units loaded in and out, transportation services arranged, etc. The billing component 260 can generate summary invoices for Goods Owners along with detailed supporting data. Additionally, in various embodiments, the billing component 260 can provide Storers with detailed information to enable audit of goods stored and payment received. The billing component 260 can track and report on cancellation fees and other non-recurring fees, where applicable.

In various embodiments, billing component 260 facilitates profit generation for an entity associated with or managing the warehouse device 120 and/or marketplace, via margin and/or markup management. The billing component 260 can enable configuration of markup on Storers' listed prices, whether in public marketplace, or directly by Storers or Goods Owners within private marketplaces, as well as markups on other fees, such as those involved in third party services (e.g., insurers, transportation providers, etc.).

The warehouse device 120 can facilitate removal of goods stored with a Storer. The inventory component 250 receives a request from a Goods Owner for removal of some or all of the goods from the space. In one embodiment, the inventory component 250 receives a selection of individual units, groups of units based on type of goods and a quantity of that type, and the like from the Goods owner. The transportation component 240 coordinates transportation of the goods to be removed from the space. The inventory component 250 ensures the appropriate goods are removed via receiving scanned information associated with goods to be removed. The billing component 260 determines an amount to be paid to the owner of the space (e.g., Storer, etc.). The amount to be paid can be based on one or more of the quantity of goods stored, the duration the goods were stored, ancillary services provided, pricing (e.g., for load-in, load-out, storage over time, ancillary services, etc.) and the like.

The warehouse device 120 can also include a communication component 270 that facilitates communications between Goods Owners and Storers, for example, via inbox messaging, and the like. In one embodiment, the communication component 270 can provide for two classifications of communications: (1) anonymous communications (e.g., between parties not engaged in a transaction, etc.), and (2) non-anonymous communications (e.g., between parties engaged in a transaction, etc.).

For anonymous communications, communication component 270 can allow parties to communicate without revealing any party's identity or contact information. For example, anonymous communications can facilitate a Storer and one or more Goods Owners asking questions related to information about a space, type(s) of goods, duration, and other properties associated with a transaction or potential. In another example, anonymous communications can facilitate communication related to discount or premium negotiation for non-standard pallet dimensions or handling procedures (e.g., oversized pallets, customized labeling, volume discounts, etc.). Additionally, the anonymous communication can provide for anonymization to protect the identity of a party before any agreement on a transactions; for example, certain Storers may not want to expose their bottom line storage prices or capacity available to competition.

The communication component 270 can facilitate non-anonymous communications, for example, between two parties engaged in a storage transaction. Non-anonymous communications can include, for example, a channel to handle special requests and conflict resolution (e.g., trucking/customs/shipping delays, billing discrepancies, changes in dates, inventory audits, lost/damaged merchandise, etc.). The communications component 270 can store a communication history between the two parties that can be tracked to an object in question; for example, to a pallet record for disputes in damages, to a delivery transport record if there are changes or delay, to an invoice record for any disputes with storage related charges, etc. In various aspects, communication component 270 can generate reminders and notifications to parties, for example, through email, text messaging, API push notification for events such as new delivery request, invoice payments, new reservation request, modification of delivery dates, etc.

The warehouse device 120 includes a warehouse services component 280 that facilitates handling of goods and/or units of goods within a warehouse. In one embodiment, the warehouse services component 280 facilitates logistics such as moving cartons of goods from a container to pallets, applying individual labels to goods and/or units of goods for shipping fulfillment, rebuilding pallets that may have been separated, case picking, and the like.

In further aspects, the warehouse device 120 can provide ancillary data analysis, which can be employed in a variety of ways, such as for market insight, sale to third parties, predictive information related to pricing, availability, etc. In aspects, the warehouse device 120 can capture data across some or all users (e.g., Storers, Goods Owners, Affiliates, non-registered users, etc.) and can store it in a searchable database to facilitate aggregate-level analysis and marketplace insight generation. Examples of insights available can include, but are not limited to: pricing trends and recommendations; capacity utilization trends; availability forecasts; pricing forecasts; sector-level trends (i.e., regional, or by storage criteria such as refrigerated, etc.); storage durations; etc. The warehouse device 120 can support subscriptions to marketplace data and/or one-off reports available for sale, which can be subject to registered users' data availability permissions.

In aspects, the warehouse device 120 can facilitate a liability model and/or insurance coverage. The warehouse device 120 can facilitate the implementation of a liability model that can include insurance coverage and risk alignment across any or all parties interacting with the subject innovation (e.g. Goods Owner, entity hosting the subject innovation, Storer, third party, etc.). The aspects can include the ability for Goods Owners to “top up” their level of coverage beyond what is in standard Terms and Conditions available through the subject innovation, for example, via a real-time transaction to buy additional coverage and have it added to the base service fee (e.g., which can be facilitated via an insurance provider or providers as partners of a host or owner of the subject innovation, etc.).

In various aspects, the warehouse device 120 can provide for Storers to store units and/or goods across multiple warehouses. In such aspects, the warehouse device 120 can implement optimization algorithms to decide the best location for units based on dimensions. Examples of dimensions which can be used for such optimization can include, but are not limited to: price (e.g., for storage, freight, etc.); distance; current inventory already stored; previous recalled pallet mixes; etc.

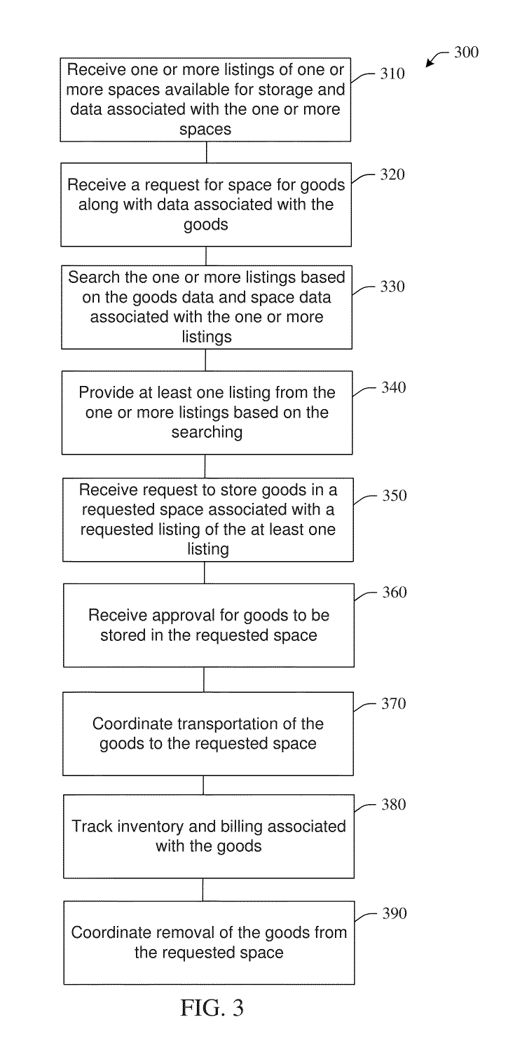

FIG. 3 illustrates a method 300 of facilitating commercial warehouse storage transactions in accordance with aspects of the subject innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts can, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with the innovation.

Method 300 can begin at 310 by receiving one or more listings of one or more commercial warehouse spaces available for storage, along with space data describing the one or more spaces, which can include, for example, location, capacity available, pricing, time period available, and other information such as that described herein. At 320, a search request for space available for storage of goods can be received, along with data associated with the goods for storage (e.g., price, quantity, time storage is requested for, location, description, etc.).

At 330, the one or more listings can be searched based on data associated with the one or more listings and the data associated with the goods for storage. At 340, at least one listing can be returned as search results and provided to a Goods Owner associated with the search request. Listings can be returned based on whether data associated with the listings match requirements or preferences associated with the search request (e.g., price, quantity of goods, time, location, etc.).

At 350, a storage request can be received to store goods in a requested space associated with a requested listing from the at least one listing, and the storage request can be provided to a Storer associated with the requested space. At 360, approval to store the goods in the requested space can be received from the Storer associated with the requested space and a reservation can be created.

At 370, transportation of the goods to the requested space can be coordinated. Transportation can involve providing unique identification for each unit of the goods (e.g., pallet, etc.), coordinating times for pickup and/or delivery, making arrangements for vehicles to transport the goods, etc. At 380, once the goods are at the requested space, inventory and billing associated with the goods can be tracked. This can include determining charges for each unit (e.g., pallet, etc.), which can include load-in/load-out pricing, price per unit per time period (e.g., per pallet per day, etc.), prices for ancillary services, etc. In one embodiment, each unit of the goods can be tracked in an inventory that maintains a description of the unit (e.g., quantities of goods, SKUs, etc.), location, etc.

At 390, in response to a pick-up request from the Goods Owner, removal of the goods from the requested space can be coordinated. In some aspects, the subject innovation can provide for search results and storage of the goods in either a spatially or temporally distributed manner (a first portion of the goods associated with a search request in a first space, a second portion in a second space, with possible additional portions in additional spaces, etc.; or storing goods or a portion thereof in a first space for a first time period, in a second space for a second time period, etc.), for example, when no listing meets the requirements (e.g., in terms of capacity, etc.) of the search request, when the search request indicates that such is acceptable, etc.

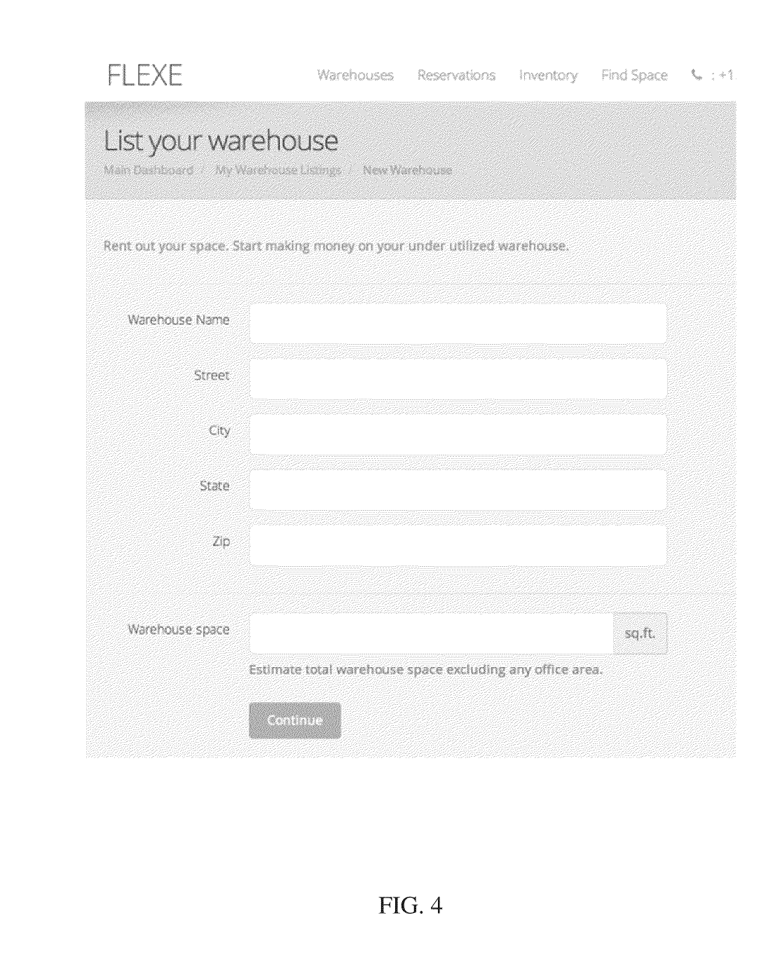

FIGS. 4-28 illustrate screenshots and other content associated with an example embodiment of the subject innovation.

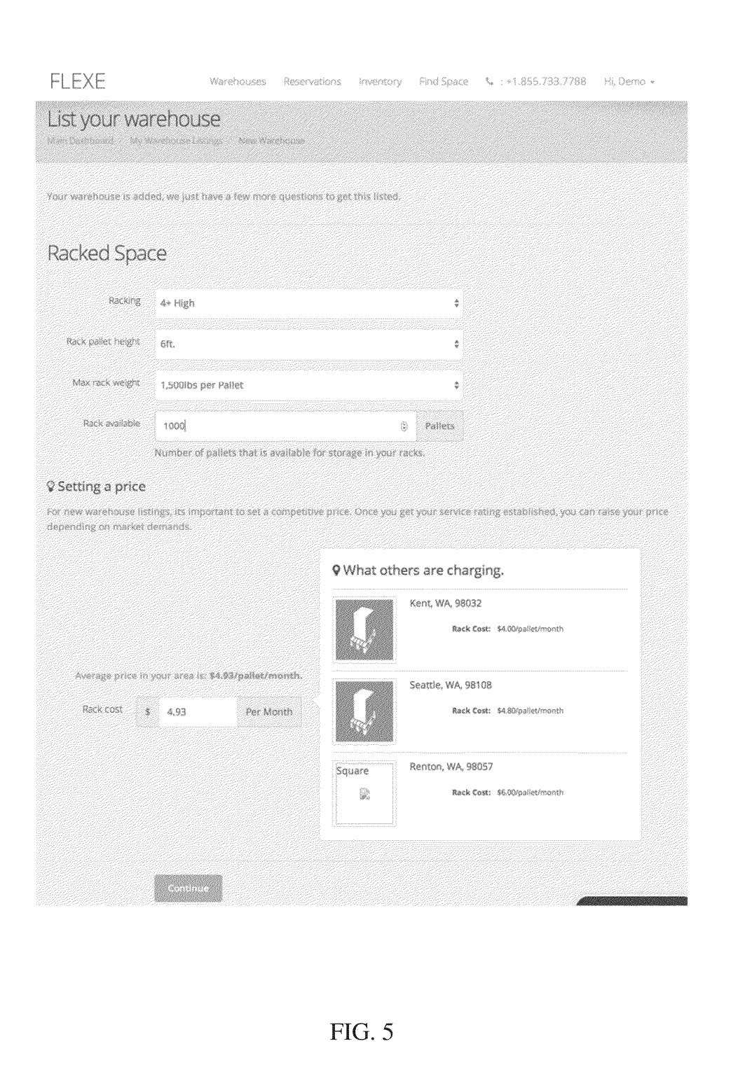

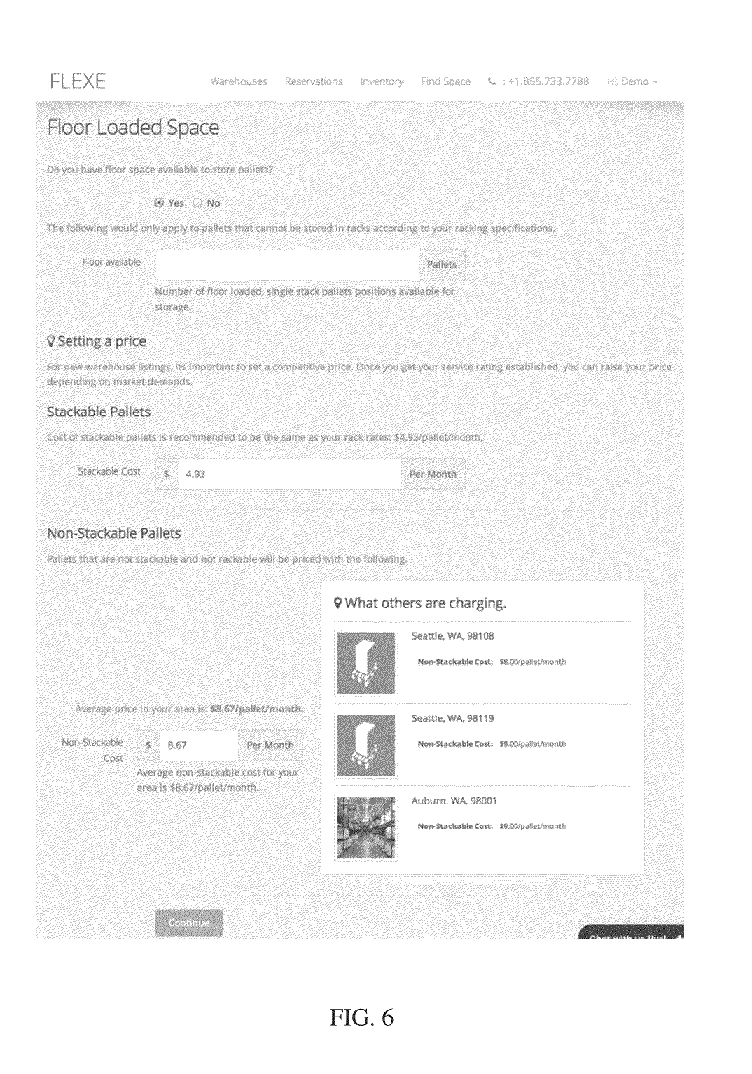

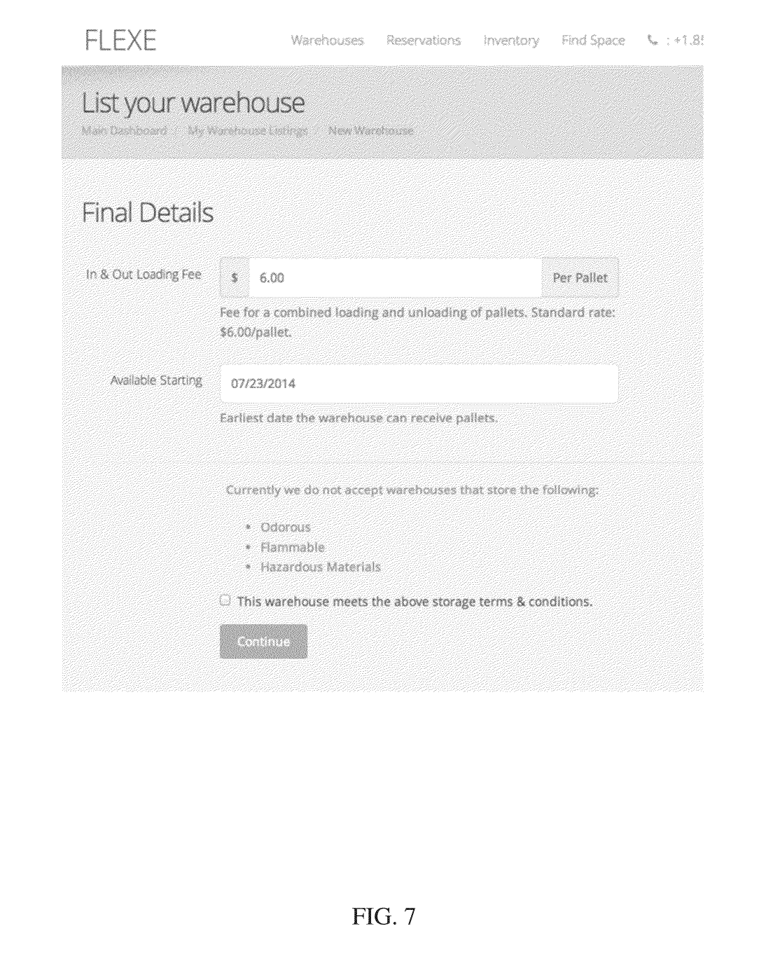

FIG. 4 illustrates an example screenshot in connection with a Storer listing space at a warehouse available for storing goods. FIG. 5 illustrates a second example screenshot in connection with a Storer listing space at a warehouse available for storing goods, showing optional features related to listing racked space and market pricing information. FIG. 6 illustrates a third screenshot in connection with a Storer listing space at a warehouse available for storing goods, showing optional features related to floor loaded space, price setting, and stackable and non-stackable pallets. FIG. 7 illustrates a fourth screenshot in connection with a Storer listing space at a warehouse available for storing goods, showing optional features related to in and out loading fees, available dates, etc.

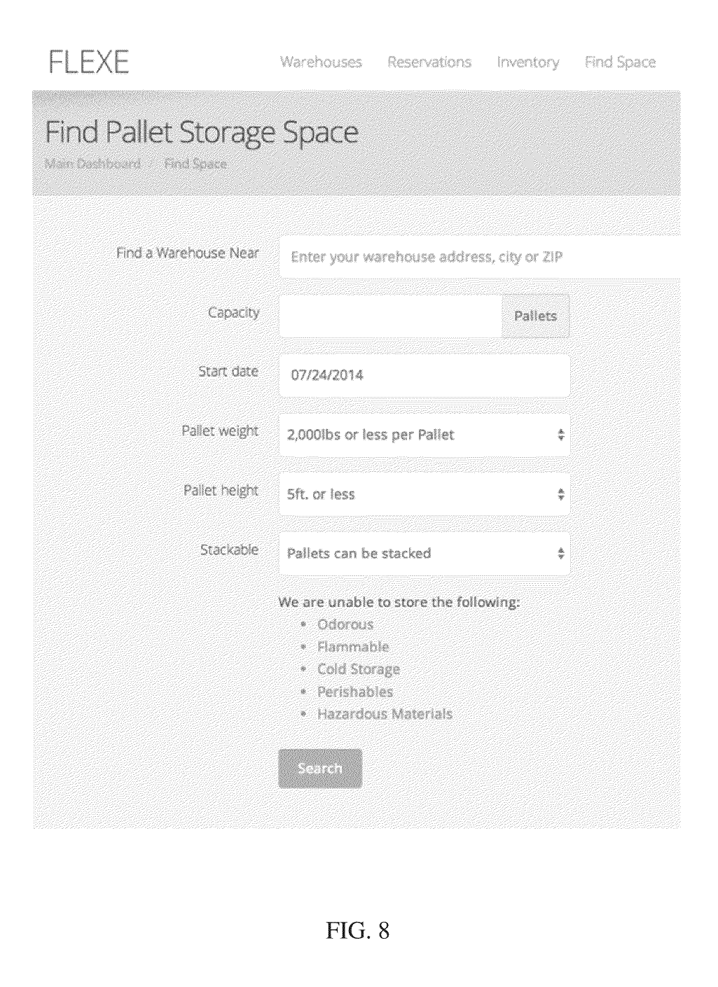

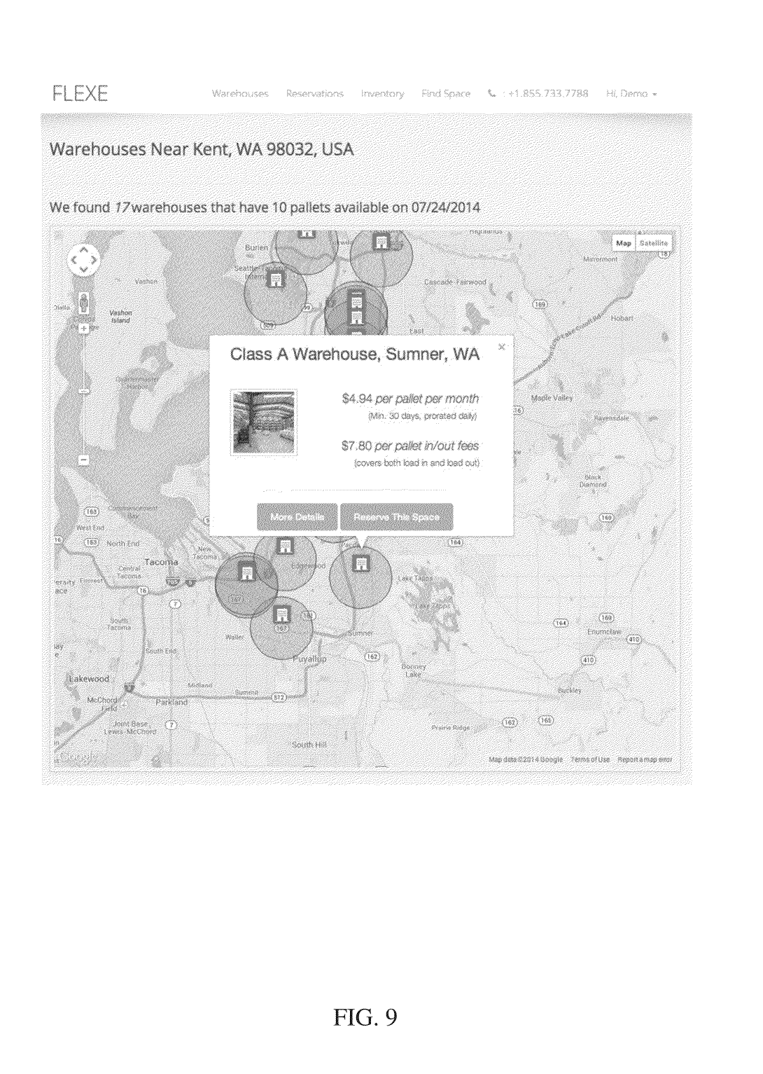

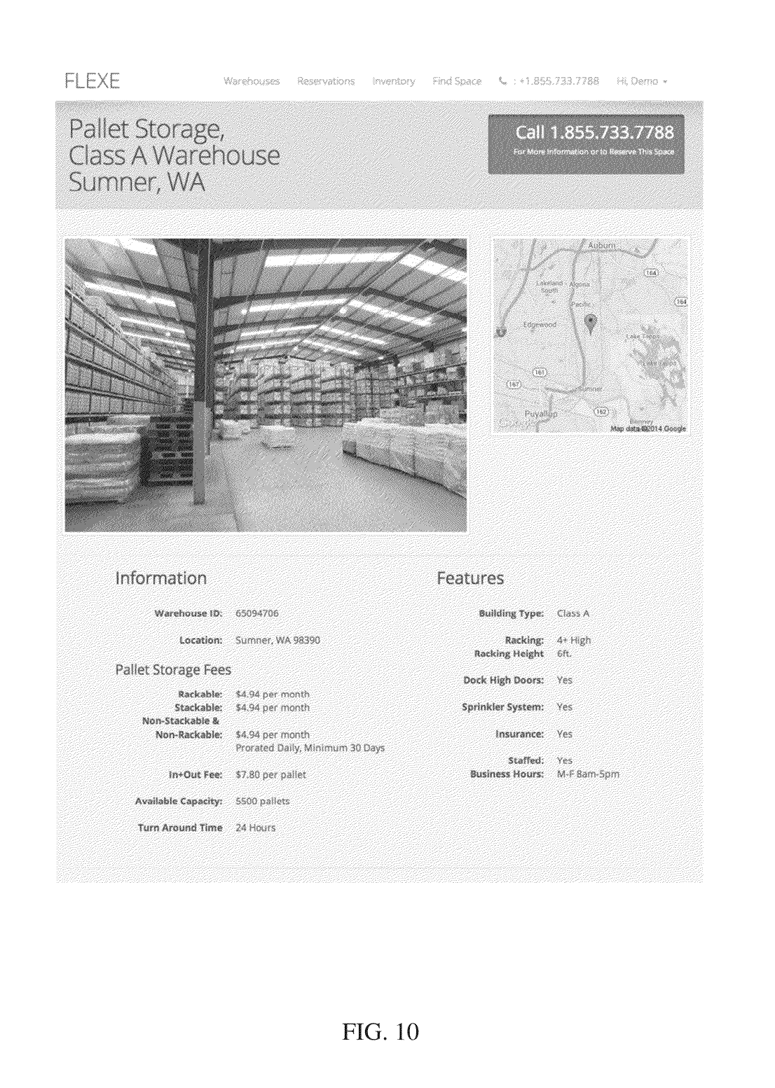

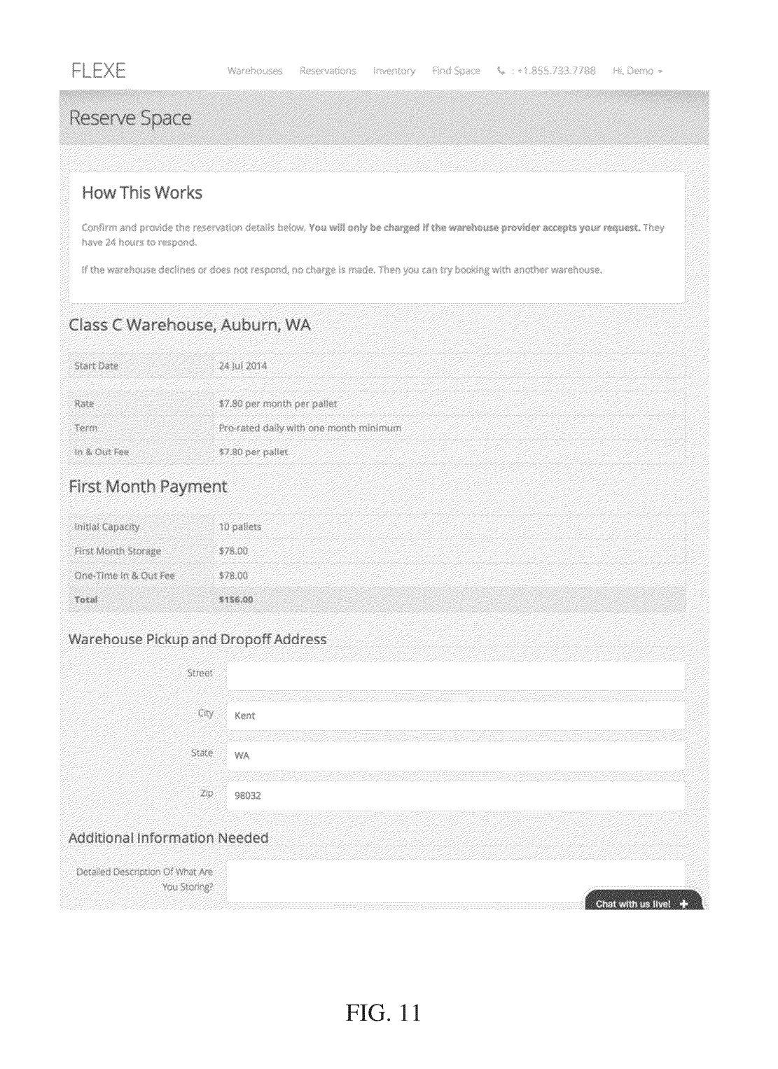

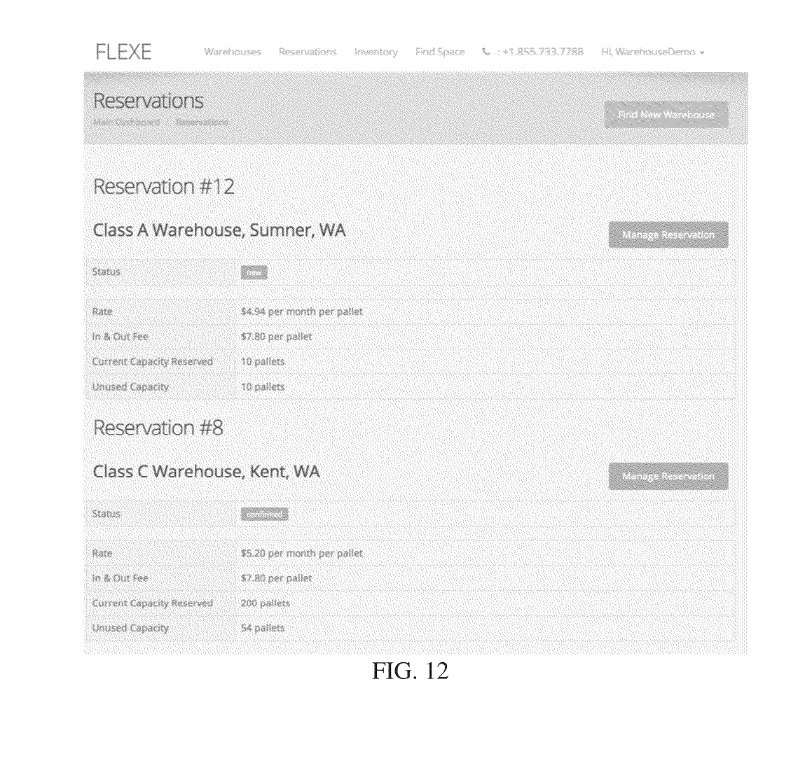

FIG. 8 illustrates an example screenshot in connection with a Goods Owner searching for storage space for goods. FIG. 9 illustrates an example screenshot of search results for commercial warehouse storage space available in response to a search request. FIG. 10 illustrates an example screenshot of a listing of a commercial storage warehouse space as presented to a Goods Owner. FIG. 11 illustrates an example screenshot of a request to reserve commercial warehouse space by a Goods Owner. FIG. 12 illustrates an example screenshot showing reservations of commercial warehouse storage space by a Goods Owner.

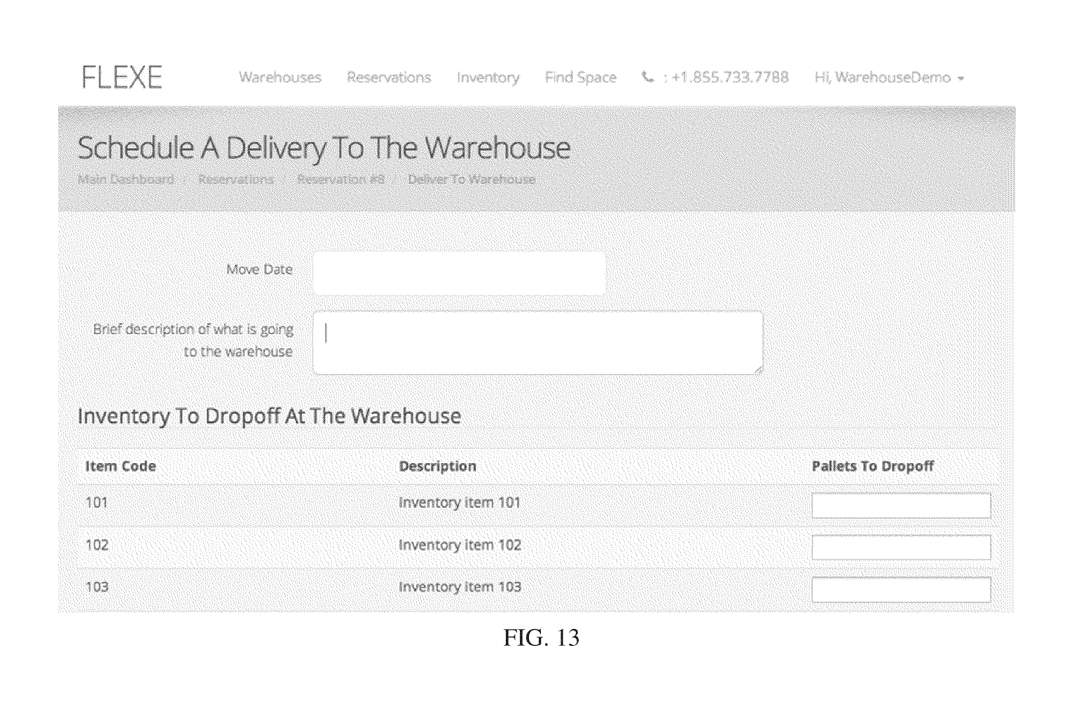

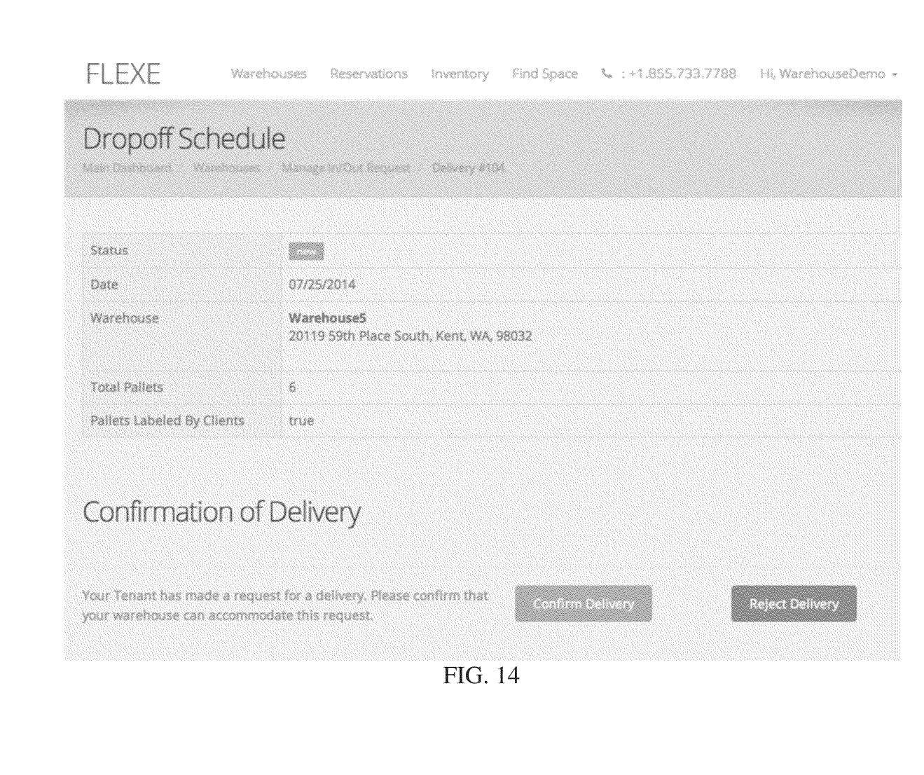

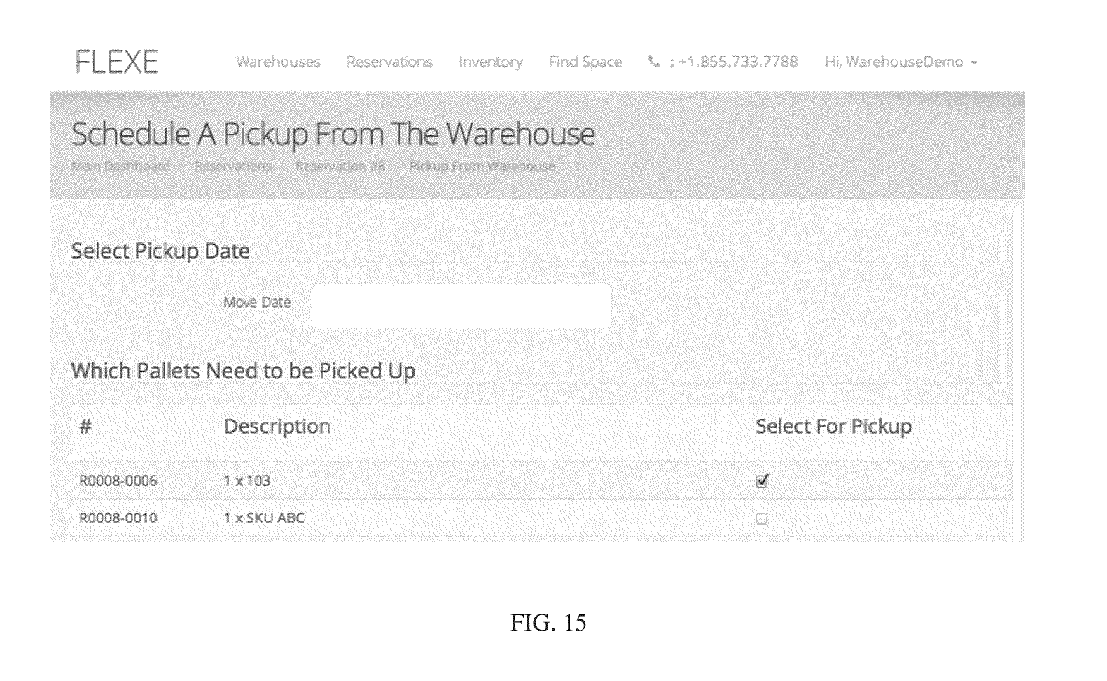

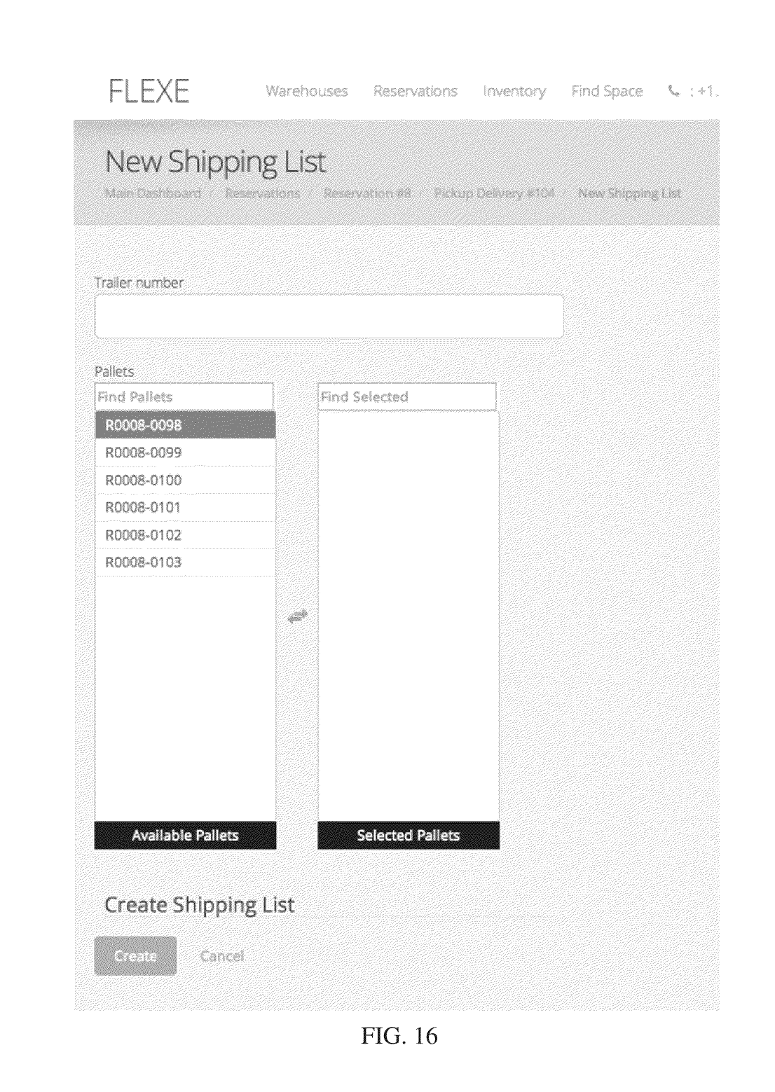

FIG. 13 illustrates an example screenshot of a Goods Owner scheduling a delivery to a warehouse. FIG. 14 illustrates an example screenshot of a scheduled delivery of goods to a warehouse. FIG. 15 illustrates an example screenshot of a scheduled pickup of goods from a warehouse. FIG. 16 illustrates an example screenshot of a shipping list of goods to be delivered to a warehouse.

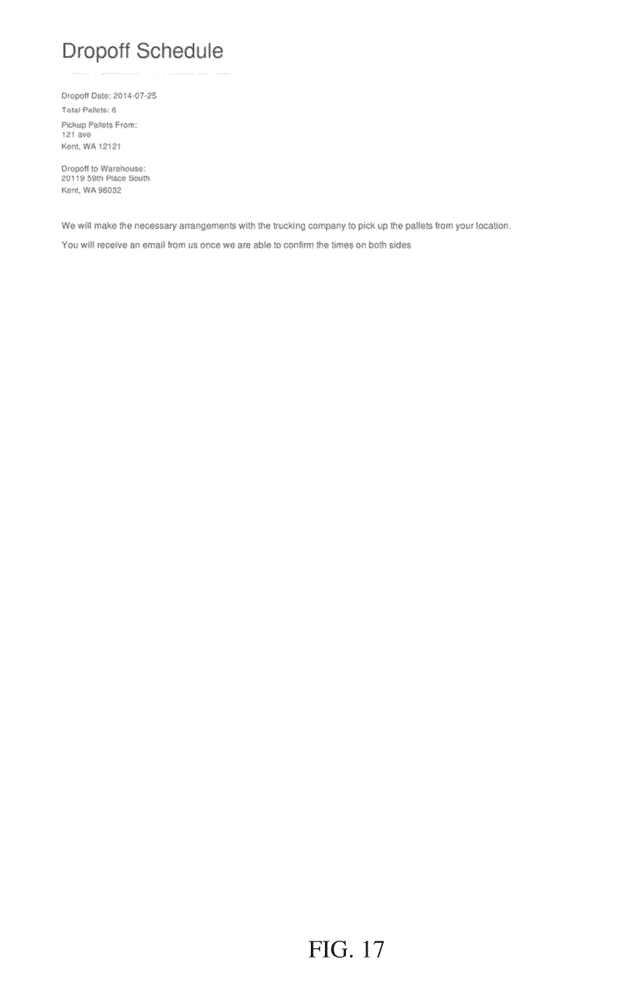

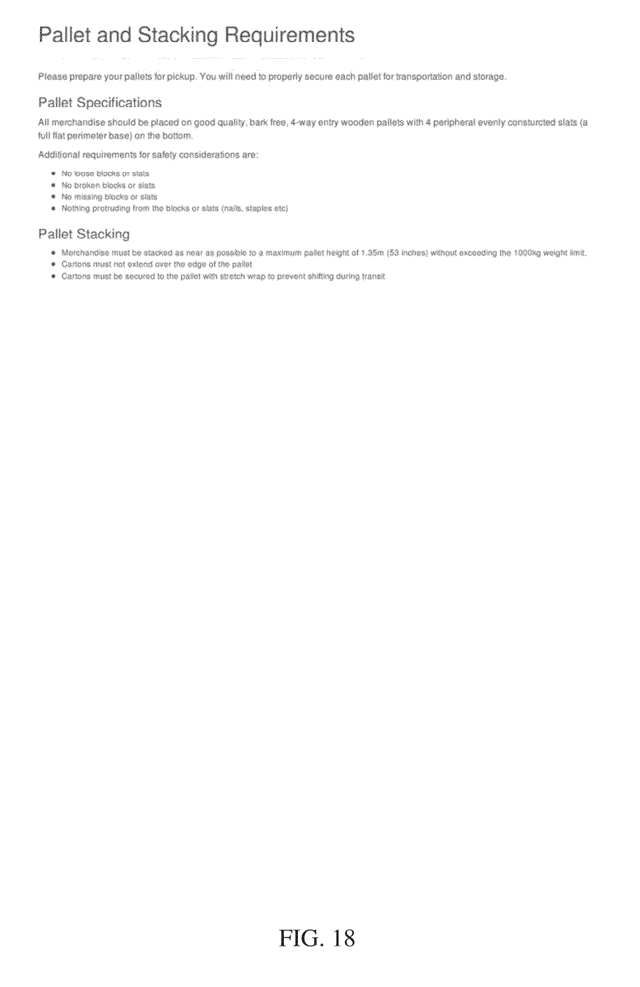

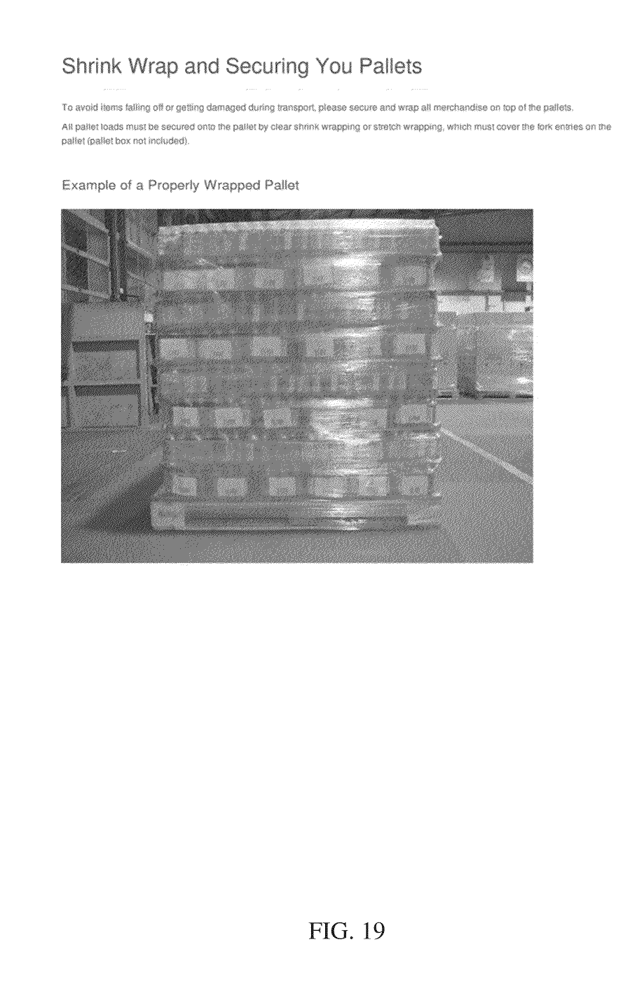

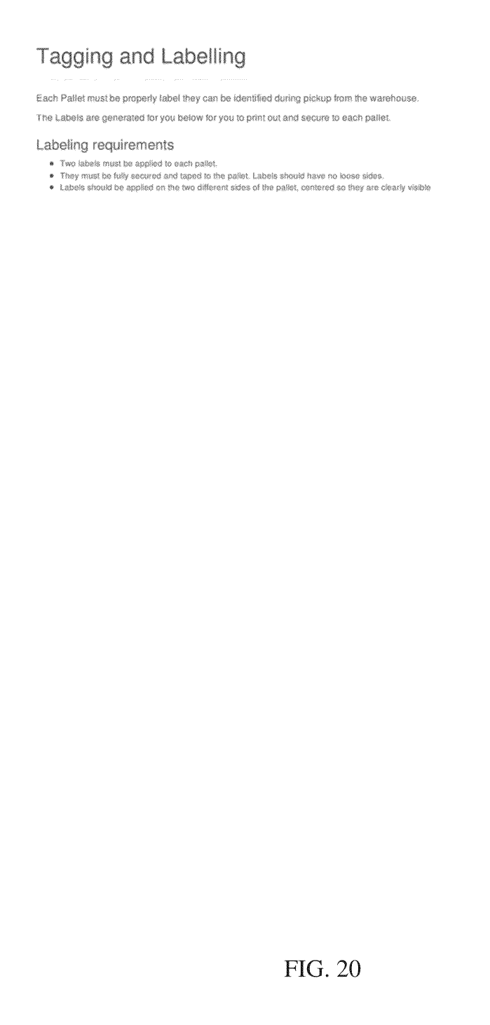

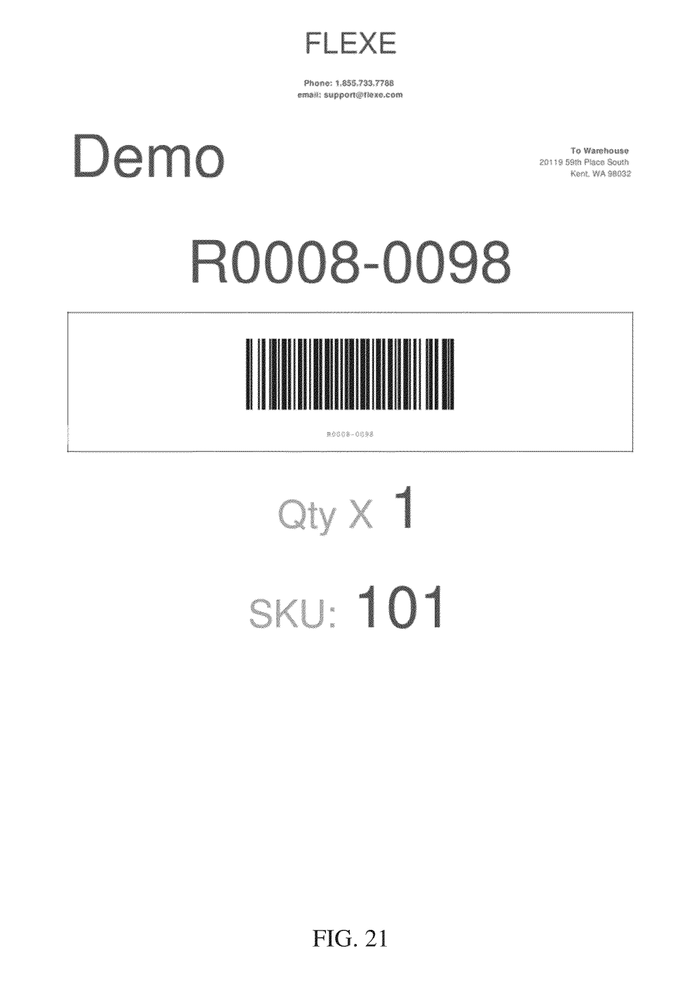

FIG. 17 illustrates a portion of an example printout confirmation of a drop-off schedule. FIG. 18 illustrates a portion of an example printout confirmation of a drop-off schedule, detailing palleting and stacking requirements. FIG. 19 illustrates a portion of an example printout confirmation of a drop-off schedule, detailing instructions for securing pallets. FIG. 20 illustrates a portion of an example printout confirmation of a drop-off schedule, detailing instructions for tagging and labeling pallets. FIG. 21 illustrates a portion of an example printout of a pallet label, showing one of two bar codes to be attached to a first pallet in connection with the goods.

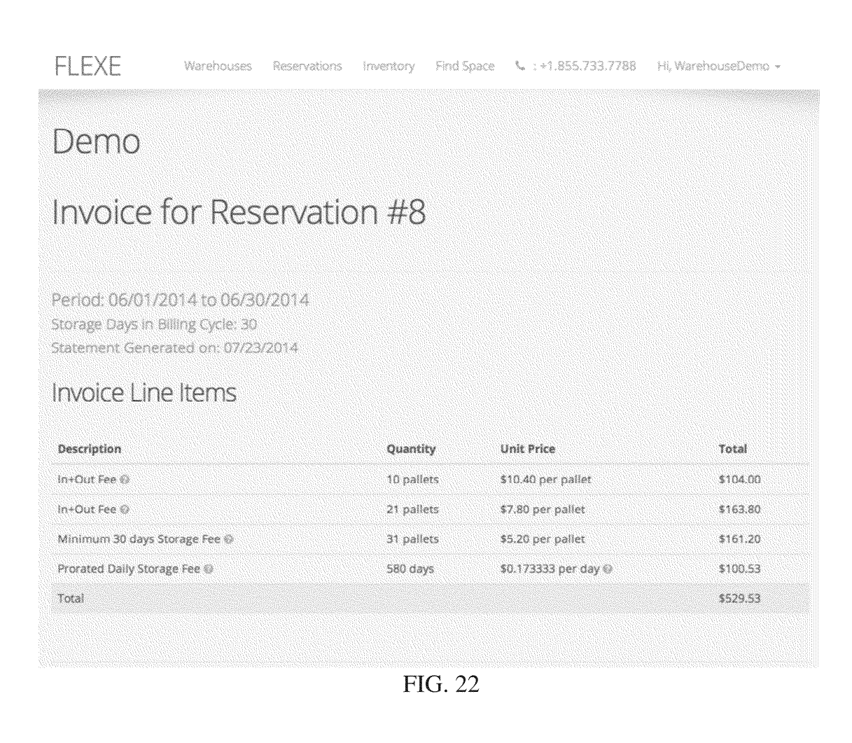

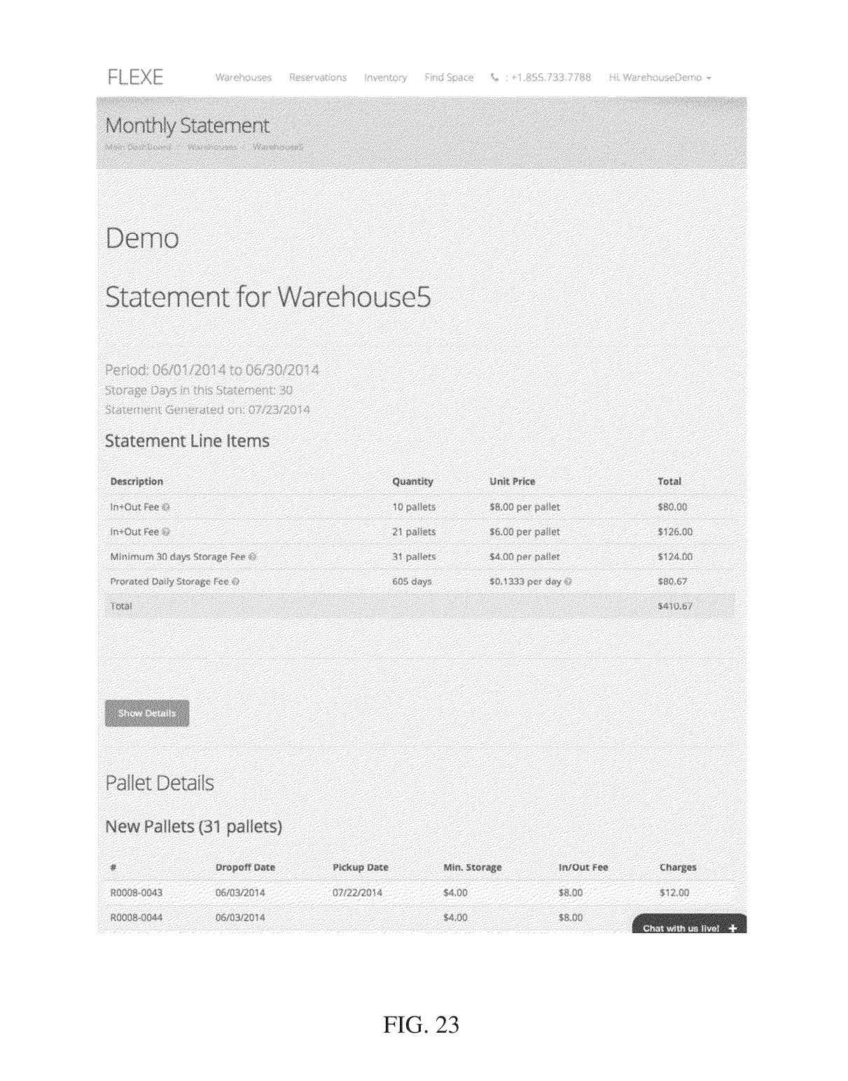

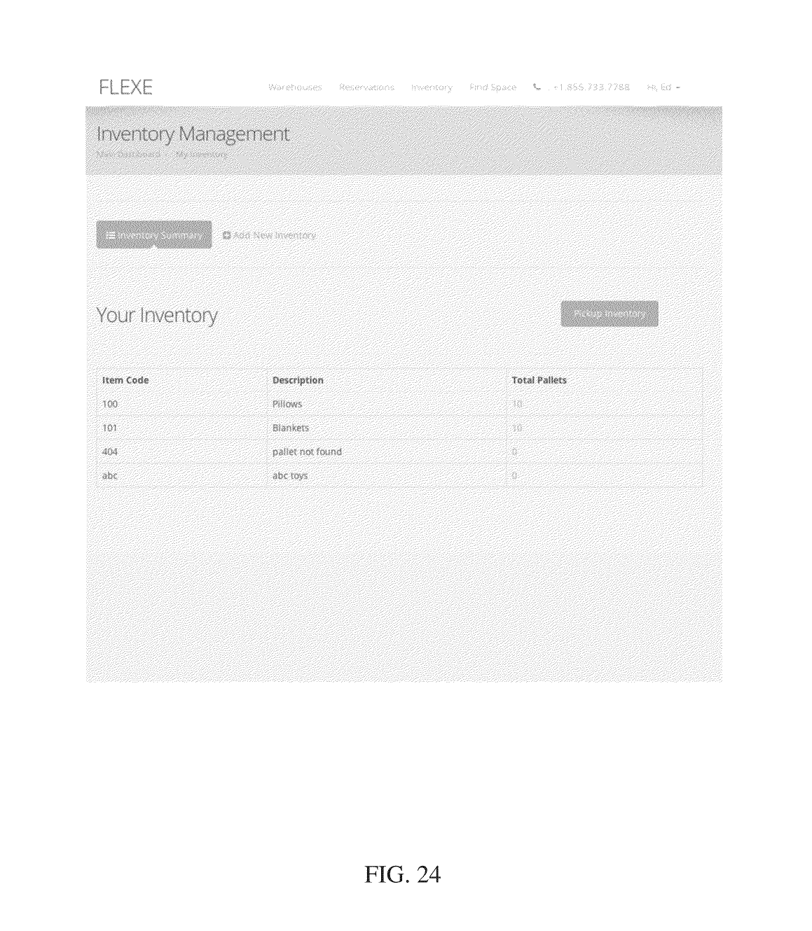

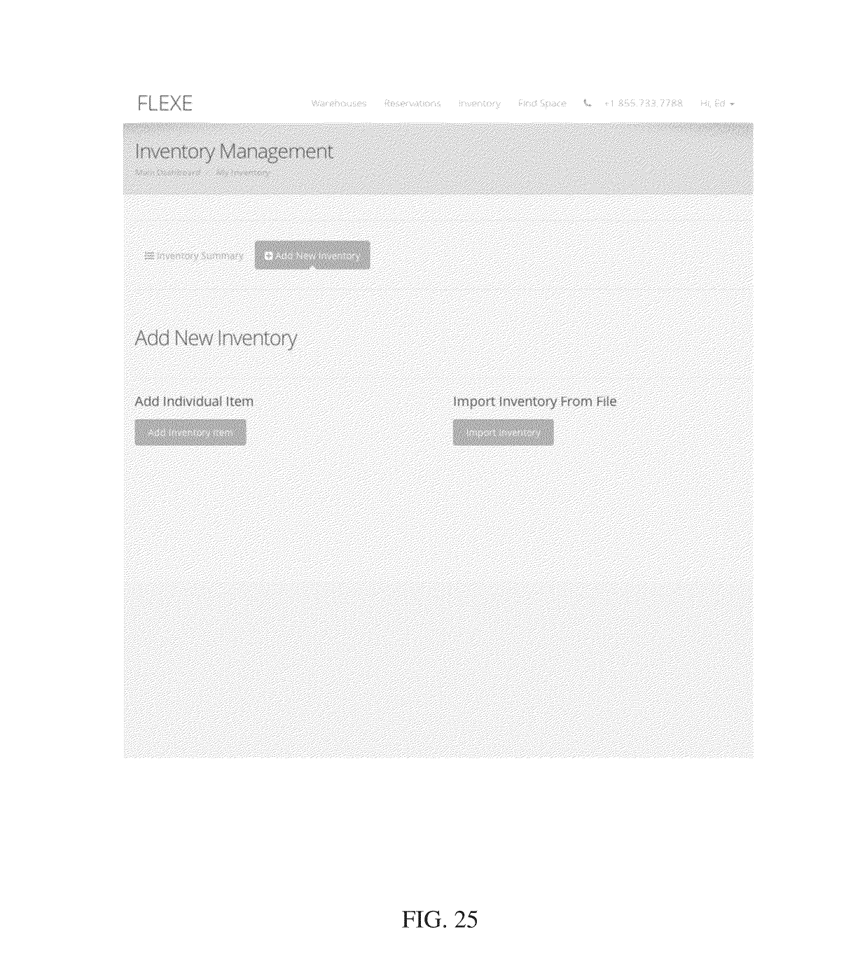

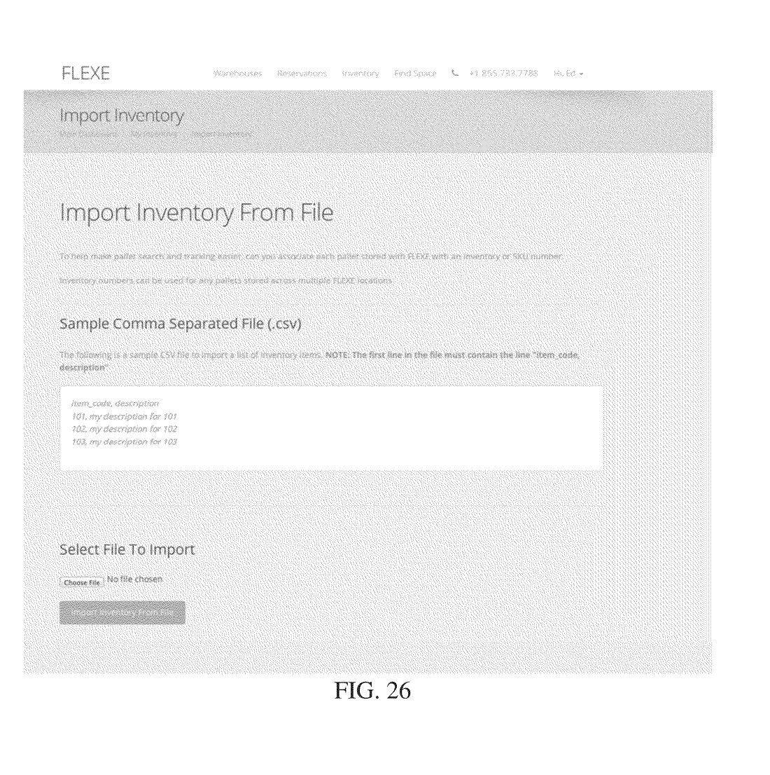

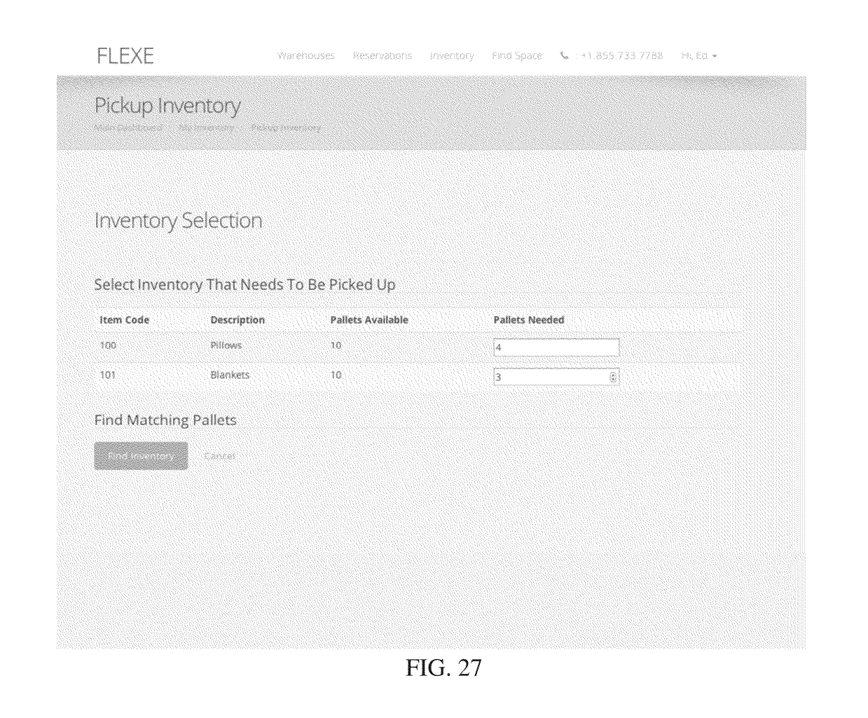

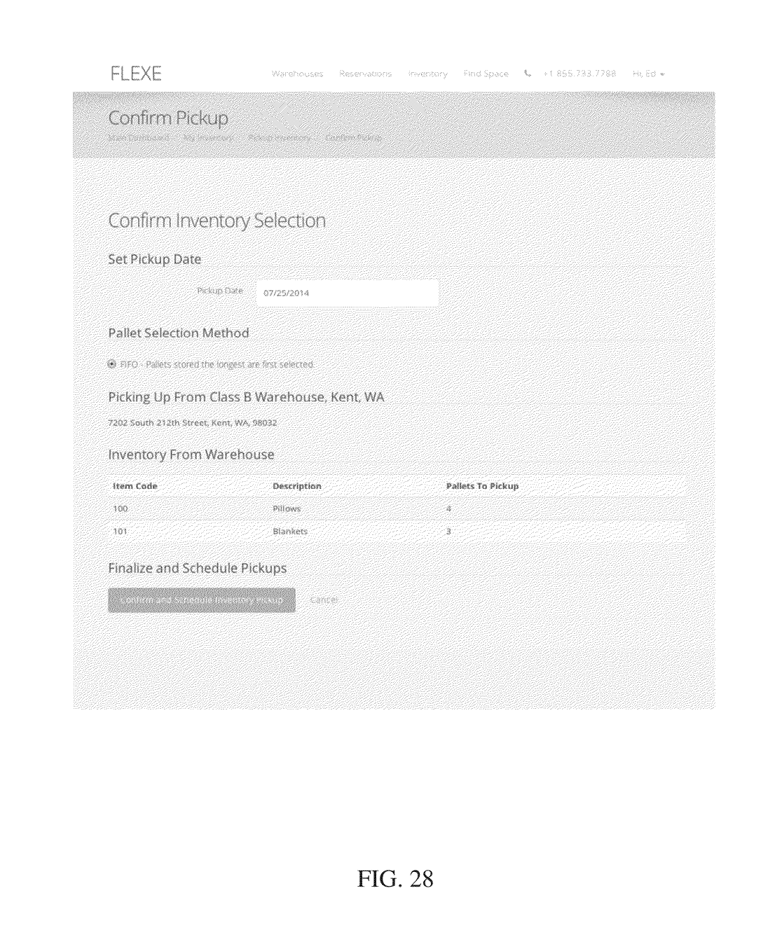

FIG. 22 illustrates an example screenshot of an invoice for a reservation of commercial warehouse storage space. FIG. 23 illustrates an example screenshot of a statement detailing goods stored at a particular warehouse, along with associated charges. FIG. 24 illustrates an example screenshot of an inventory management interface, showing an overview of what a Goods Owner has stored at warehouses associated with the subject innovation. FIG. 25 illustrates an example screenshot of an inventory management interface, showing options to add new inventory items, either individually or imported from a file. FIG. 26 illustrates an example screenshot of an inventory management interface, showing new inventory items being added via importing items from a CSV file. FIG. 27 illustrates an example screenshot of an inventory management interface, showing an inventory pickup interface. The subject innovation can provide a way to intelligently find inventory across multiple storage locations and automatically organize shipments based on various cost factors (e.g., minimum number of locations, shortest distance, goods that have been stored the longest, etc.). FIG. 28 illustrates an example screenshot of an inventory management interface, showing the results of a proposed inventory pickup generated by the subject innovation. The subject innovation provides the capability to schedule pickups from multiple locations with one click, although in FIG. 28 all inventory needed was found from one warehouse.

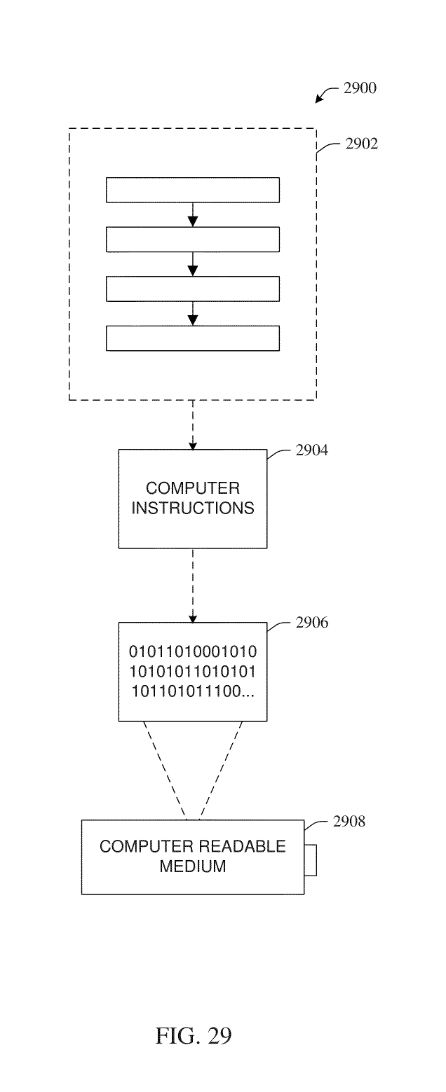

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 29, wherein an implementation 2900 comprises a computer-readable medium 2908, such as a CD-R, DVD-R, flash drive, a platter of a hard disk drive, etc., on which is encoded computer-readable data 2906. This computer-readable data 2906, such as binary data comprising a plurality of zero's and one's as shown in 2906, in turn comprises a set of computer instructions 2904 configured to operate according to one or more of the principles set forth herein. In one such embodiment 2900, the processor-executable computer instructions 2904 is configured to perform a method 2902, such as at least a portion of one or more of the methods described in connection with embodiments disclosed herein. In another embodiment, the processor-executable instructions 2904 are configured to implement a system, such as at least a portion of one or more of the systems described in connection with embodiments disclosed herein. Many such computer-readable media can be devised by those of ordinary skill in the art that are configured to operate in accordance with the techniques presented herein.

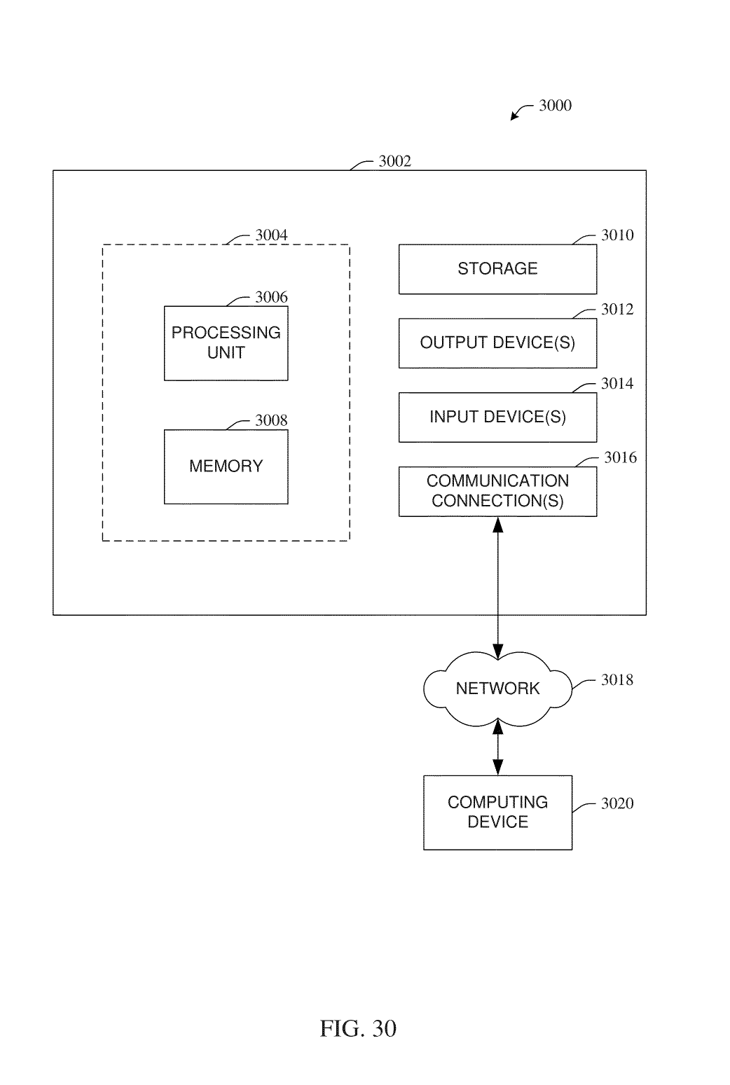

FIG. 30 and the following discussion provide a description of a suitable computing environment in which embodiments of one or more of the provisions set forth herein can be implemented. The operating environment of FIG. 30 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 30 illustrates a system 3000 comprising a computing device 3002 configured to implement one or more embodiments provided herein. In one configuration, computing device 3002 can include at least one processing unit 3006 and memory 3008. Depending on the exact configuration and type of computing device, memory 3008 can be volatile, such as RAM, non-volatile, such as ROM, flash memory, etc., or some combination of the two. This configuration is illustrated in FIG. 30 by dashed line 3004.

In these or other embodiments, device 3002 can include additional features or functionality. For example, device 3002 can also include additional storage such as removable storage or non-removable storage, including, but not limited to, magnetic storage, optical storage, and the like. Such additional storage is illustrated in FIG. 30 by storage 3010. In some embodiments, computer readable instructions to implement one or more embodiments provided herein are in storage 3010. Storage 3010 can also store other computer readable instructions to implement an operating system, an application program, and the like. Computer readable instructions can be loaded in memory 3008 for execution by processing unit 3006, for example.

The term “computer readable media” as used herein includes computer storage media. Computer storage media includes volatile and nonvolatile, removable and non-removable media implemented in any method or technology for storage of information such as computer readable instructions or other data. Memory 3008 and storage 3010 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 3002. Any such computer storage media can be part of device 3002.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 3002 can include one or more input devices 3014 such as keyboard, mouse, pen, voice input device, touch input device, infrared cameras, video input devices, or any other input device. One or more output devices 3012 such as one or more displays, speakers, printers, or any other output device can also be included in device 3002. The one or more input devices 3014 and/or one or more output devices 3012 can be connected to device 3002 via a wired connection, wireless connection, or any combination thereof. In some embodiments, one or more input devices or output devices from another computing device can be used as input device(s) 3014 or output device(s) 3012 for computing device 3002. Device 3002 can also include one or more communication connections 3016 that can facilitate communications with one or more other devices 3020 by means of a communications network 3018, which can be wired, wireless, or any combination thereof, and can include ad hoc networks, intranets, the Internet, or substantially any other communications network that can allow device 3002 to communicate with at least one other computing device 3020.

What has been described above includes examples of the innovation. It is, of course, not possible to describe every conceivable combination of components or methodologies for purposes of describing the subject innovation, but one of ordinary skill in the art can recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A warehouse device that facilitates commercial warehouse storage transactions, comprising:
a matching component that matches a search request for space in which a set of goods can be stored, wherein the search request comprises goods data associated with the set of goods to one or more listings of one or more commercial warehouse spaces available for storage where each of the one or more listings comprises space data describing the one or more spaces; and
a transaction component that receives approval from a Storer to store the goods in the requested space.

2. The warehouse device of claim 1, comprising:
a marketplace database component configured to:
receive one or more listings of one or more commercial warehouse spaces available for storage;
receive the search request for space;
search the one or more listings based at least in part on the goods data and the space data of the one or more listings;
provide at least one listing of the one or more listings as a search result; and
the transaction component receives a request to store the set of goods in a requested space associated with a requested listing form the at least one listing and provides the request to the Storer associated with the requested space.

3. The warehouse device of claim 1, wherein the matching component utilizes one or more matching algorithms.

4. The warehouse device of claim 1, comprising:
a transportation component that coordinates transportation of the set of goods to the requested space and required materials handling, wherein the coordinating includes contacting at least one affiliate of the Storer to transport the set of goods.

5. The warehouse device of claim 1, comprising:
an inventory component that tracks the set of goods as inventory when stored with the Storer, wherein the set of goods is divided into a plurality of units of goods.

6. The warehouse device of claim 5, wherein the inventory component associates a unique identifier with each unit of goods, wherein the unique identifier includes location data and generates the inventory for the set of goods having the location of each unit of goods.

7. The warehouse device of claim 1, comprising:
a billing component that generates billing associated with the set of goods while at the requested space, wherein the billing is based on one of load-in and load-out prices, prices per unit time for each unit of goods, or pricing for ancillary services.

8. The warehouse device of claim 1, wherein the transaction component coordinates removal of the set of goods from the requested space in response to a pick-up request.

9. The warehouse device of claim 8, comprising:
the transaction component receives a pick-up request for removal of the set of goods form the Storer;
the inventory component determines the location of each unit of goods;
a warehouse services component compiles each unit of goods into the set of goods; and
the transportation component coordinates transport of the set of goods to the destination.

10. A method, comprising:
matching a search request for space in which a set of goods can be stored, wherein the search request comprises goods data associated with the set of goods to one or more listings of one or more commercial warehouse spaces available for storage where each of the one or more listings comprises space data describing the one or more spaces;
receiving approval from a Storer to store the goods in the requested space; and
coordinating storage of the set of goods with the Storer.

11. The method of claim 10, wherein the matching comprises:
receiving the one or more listings of one or more commercial warehouse spaces available for storage;
receiving the search request for space;
searching the one or more listings based at least in part on the goods data and the space data of the one or more listings;
providing at least one listing of the one or more listings as a search result;
receiving a request to store the set of goods in a requested space associated with a requested listing from the at least one listing; and
providing the request to a Storer associated with the requested space.

12. The method of claim 10, wherein the matching includes utilizing one or more matching algorithms.

13. The method of claim 10, comprising:
coordinating transportation of the set of goods to the requested space and required materials handling, wherein the coordinating includes contacting at least one affiliate of the Storer to transport the set of goods.

14. The method of claim 10, further comprising:
tracking the set of goods as inventory when stored with the Storer, wherein the set of goods is divided into a plurality of units of goods.

15. The method of claim 14, wherein the tracking comprises:
associating a unique identifier with each unit of goods, wherein the unique identifier includes location data; and
generating the inventory for the set of goods having the location of each unit of goods.

16. The method of claim 10, comprising:
generating billing associated with the set of goods while at the requested space, wherein the billing is based on one of load-in and load-out prices, prices per unit time for each unit of goods, or pricing for ancillary services.

17. The method of claim 10, further comprising coordinating removal of the set of goods from the requested space in response to a pick-up request.

18. The method of claim 10, wherein coordinating removal comprises:
receiving a pick-up request for removal of the set of goods from the Storer;
determining location of each unit of goods;
compiling each unit of goods into the set of goods;
determining destination of the set of goods for transport; and
coordinating transport of the set of goods to the destination.

19. A computer readable medium having instructions for controlling one or more processors configured to:
facilitate storage of a set of goods in response to a search request, wherein the search request comprises goods data associated with the set of goods to one or more listings of one or more commercial warehouse spaces available for storage where each of the one or more listings comprises space data describing the one or more spaces; and
apply warehouse services on the set of goods.

20. The computer readable medium of claim 19, wherein the warehouse services comprise at least one of moving units of goods from a container to pallets, applying individual shipping labels to units of goods, rebuilding pallets, or case picking.
